(19) United States
(12) Patent Application Publication
(10) Pub. No.: US 2025/0362639 A1
(43) Pub. Date: Nov. 27, 2025

(54) ELECTROPHOTOGRAPHIC CLEANING BLADE, PROCESS CARTRIDGE AND ELECTROPHOTOGRAPHIC IMAGE FORMING APPARATUS

(71) Applicant: CANON KABUSHIKI KAISHA, Tokyo (JP)

(72) Inventors: MASANORI YOKOYAMA, Shizuoka (JP); SHOTA SEGAWA, Shizuoka (JP); YUICHI KIKUCHI, Shizuoka (JP); ARIHIRO YAMAMOTO, Shizuoka (JP)

(21) Appl. No.: 19/293,066

(22) Filed: Aug. 7, 2025

Related U.S. Application Data
(63) Continuation of application No. PCT/JP2024/004793, filed on Feb. 13, 2024.

(30) Foreign Application Priority Data
Feb. 14, 2023 (JP) 2023-020665

(51) Int. Cl. G03G 21/00; G03G 21/18

(52) U.S. Cl. CPC G03G 21/0017; G03G 21/0029; G03G 21/1814

(57) ABSTRACT

An electrophotographic cleaning blade including an elastic member and a support member that supports the elastic member, wherein the elastic member has, at a free end portion of the elastic member, a first surface and a second surface that constitutes an edge together with the first surface; when dynamic hardness is measured at predetermined measurement positions, the coefficient of variation of a maximum value DHmax among the dynamic hardnesses at measurement positions in the longitudinal direction of the elastic member is not more than 0.20, the elastic member has a region where the dynamic hardness decreases from the edge toward the inside of the elastic member; and in the region where the dynamic hardness decreases, the coefficient of variation of the distance L between the predetermined measurement position and the edge in the longitudinal direction of the elastic member is not more than 0.28.

### CROSS-REFERENCE TO RELATED APPLICATION

This application is a Continuation of International Patent Application No. PCT/JP2024/004793, filed Feb. 13, 2024, which claims the benefit of Japanese Patent Application No. 2023-020665 filed Feb. 14, 2023, both of which are hereby incorporated by reference herein in their entirety.

### BACKGROUND

### Field of the Technology

The present disclosure relates to an electrophotographic cleaning blade used in an electrophotographic image forming apparatus, a process cartridge and an electrophotographic image forming apparatus.

### Description of the Related Art

Conventionally, an electrophotographic image forming apparatus (hereinafter referred to as an “electrophotographic apparatus”) is available that includes various cleaning members in order to remove toner remaining on an image bearing member such as a photosensitive member after a toner image is transferred from the image bearing member onto a transfer target member such as paper or an intermediate transfer medium.

As the cleaning member, an electrophotographic cleaning blade (hereinafter simply referred to as a cleaning blade) using a plate-like elastic member is well-known, and the elastic member is often made of particularly a polyurethane elastomer.

In addition, in recent years, with higher image quality of the electrophotographic apparatus, toner particles have become smaller in diameter and more spherical, and the toner remaining on the image bearing member is more likely to slip through the cleaning blade. Accordingly, higher cleaning performance is required for the cleaning blade.

Here, as a method of improving cleaning performance, a method of increasing the hardness of a contact portion of a cleaning blade formed of a polyurethane elastomer, and reducing the contact nip width, and thus increasing the force of contact of the cleaning blade with the image bearing member is known.

Japanese Patent Laid-Open No. 2019-132982 proposes a method of producing an electrophotographic device blade, the method including impregnating a contact region contacting with a counter member with a blocked isocyanate, releasing a blocking agent from the blocked isocyanate, and reacting the free isocyanate with urethane rubber to form a cured layer having a small variation in surface hardness, wherein the isocyanate includes an aromatic isocyanate.

In addition, Japanese Patent Laid-Open No. 2004-233818 discloses an electrophotographic device blade that is used in contact with a contact target member, and in the electrophotographic device blade, at least a contact region of the blade is formed in a silicon layer in which the silicon content decreases from the surface layer of the contact region toward the inside, and the surface layer of the silicon layer is formed in a cured layer.

In addition, Japanese Patent Laid-Open No. 2016-142860 discloses a cleaning blade in which a contact region contacting with a counter member is impregnated with a curable composition containing a (meth)acrylate compound, and the amount of the curable composition decreases from the surface toward the inside.

### SUMMARY

At least one aspect of the present disclosure is to provide a cleaning blade that minimizes momentary slip-through of a toner remaining on a cleaning target member caused by a change in the contact orientation of the cleaning blade relative to the cleaning target member when the electrophotographic image forming operation starts or when an electrophotographic image forming operation stops, and contributes to stable formation of high-quality electrophotographic images. In addition, at least one aspect of the present disclosure is to provide a process cartridge that contributes to stable formation of high-quality electrophotographic images. In addition, at least one aspect of the present disclosure is to provide an electrophotographic image forming apparatus.

According to at least one aspect of the present disclosure, an electrophotographic cleaning blade comprising an elastic member and a support member that supports the elastic member, wherein the elastic member has, at a free end portion of the elastic member, a first surface and a second surface that constitutes an edge together with the first surface, in a cross section perpendicular to a longitudinal direction of the elastic member, and on a straight line that bisects an angle of the edge, when dynamic hardness is measured at measurement positions at 10 μm intervals from the edge, coefficient of variation of a maximum value DHmax among dynamic hardnesses at the measurement positions in the longitudinal direction of the elastic member is not more than 0.20, the elastic member has a region where the dynamic hardness decreases from the edge toward the inside of the elastic member, and in the region where the dynamic hardness decreases, coefficient of variation of a distance L in the longitudinal direction of the elastic member between the edge and a measurement position positioned on an inside of the elastic member when an amount, by which the dynamic hardness decreases at two adjacent measurement positions, becomes not more than 0.04 for the first time is not more than 0.28 can be provided.

In addition, according to at least one aspect of the present disclosure, a process cartridge comprising the cleaning blade of the present disclosure can be provided.

Furthermore, according to at least one aspect of the present disclosure, an electrophotographic image forming apparatus comprising the cleaning blade of the present disclosure can be provided.

Features of the present disclosure will become apparent from the following description of embodiments with reference to the attached drawings.

### BRIEF DESCRIPTION OF THE DRAWINGS

FIG. 1A shows an example of an integral molding type cleaning blade. FIG. 1B shows an example of an adhesive type cleaning blade.

FIG. 2 is a diagram showing a state in which an edge of the cleaning blade is in contact with a cleaning target member when a process cartridge is resting. The longitudinal direction (X direction) of the elastic member is a direction perpendicular to the plane of the paper in the drawing.

FIG. 3 is a diagram showing a state in which the cleaning blade is in contact with the cleaning target member when the process cartridge operates.

FIG. 4A is a perspective view illustrating a method of cutting out a measurement sample. FIG. 4B is a side view illustrating a method of cutting out a measurement sample.

FIG. 5 is a diagram showing cutting out a sample for measuring the dynamic hardness in a cross section perpendicular to the longitudinal direction of the elastic member.

FIG. 6 is a diagram showing measurement points for the dynamic hardness in a cross section perpendicular to the longitudinal direction of the elastic member.

FIG. 7 is a diagram showing profiles of the dynamic hardnesses measured at the points on a straight line that bisects an angle of the edge in cleaning blades according to Example 1 and Example 3.

FIG. 8A shows a precursor in which the length of soft segments between crosslinking points is uniform, and FIG. 8B shows a precursor in which the length of soft segments between crosslinking points is non-uniform.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

According to studies by the inventors, it has been confirmed that, in the electrophotographic device blades and cleaning blades disclosed in Japanese Patent Laid-Open No. 2019-132982, Japanese Patent Laid-Open No. 2004-233818, and Japanese Patent Laid-Open No. 2016-142860, when a portion that comes into contact with a cleaning target member is cured, an effect of improving cleaning performance to a certain level is obtained. However, it has been found that, in a portion of the cleaning target member with which the cleaning blade comes in contact when an electrophotographic image forming operation stops or starts, the toner may locally slip through and image defects may occur. Thus, the inventors conducted further studies in order to find the cause of such a phenomenon. As a result, it has been found that the depth of the surface portion of the cleaning blade subjected to the curing treatment is non-uniform in the longitudinal direction of the cleaning blade, and this non-uniformity causes the contact orientation of the free end portion of the cleaning blade in the longitudinal direction against the cleaning target member to be unstable when the electrophotographic image forming operation stops or starts. In addition, it has been found that, by using the cleaning blade in which the depth of the surface portion subjected to the curing treatment is made uniform in the longitudinal direction, the contact orientation of the free end portion of the cleaning blade against the cleaning target member is stabilized in the longitudinal direction when the electrophotographic image forming operation stops or starts, and thus the above local toner slip-through can be prevented.

That is, the cleaning blade according to one aspect of the present disclosure includes an elastic member and a support member that supports the elastic member. The elastic member has a first surface at a free end portion of the elastic member and a second surface that constitutes an edge together with the first surface, in a cross section perpendicular to the longitudinal direction of the elastic member, and on a straight line that bisects an angle of the edge, when the dynamic hardness is measured at measurement positions 10 μm away from the edge, the coefficient of variation of the maximum value DHmax among the dynamic hardnesses at the measurement positions in the longitudinal direction of the elastic member is 0.20 or less. In addition, the elastic member has a region where the dynamic hardness decreases from the edge toward the inside of the elastic member, and in the region where the dynamic hardness decreases, the coefficient of variation of the distance L in the longitudinal direction of the elastic member between the edge and a measurement position positioned inside the elastic member when the amount by which the dynamic hardness decreases at two adjacent measurement positions becomes 0.04 or less for the first time is 0.28 or less.

Examples of cleaning target members to which an electrophotographic cleaning blade according to at least one aspect of the present disclosure (hereinafter simply referred to as a “cleaning blade”) is applied include image bearing members such as a photosensitive member and endless belts such as an intermediate transfer belt. Hereinafter, using an image bearing member as an example of a cleaning target member, an embodiment of a cleaning blade according to at least one aspect of the present disclosure will be described in detail, but the present disclosure is not limited thereto.

### Configuration of Cleaning Blade

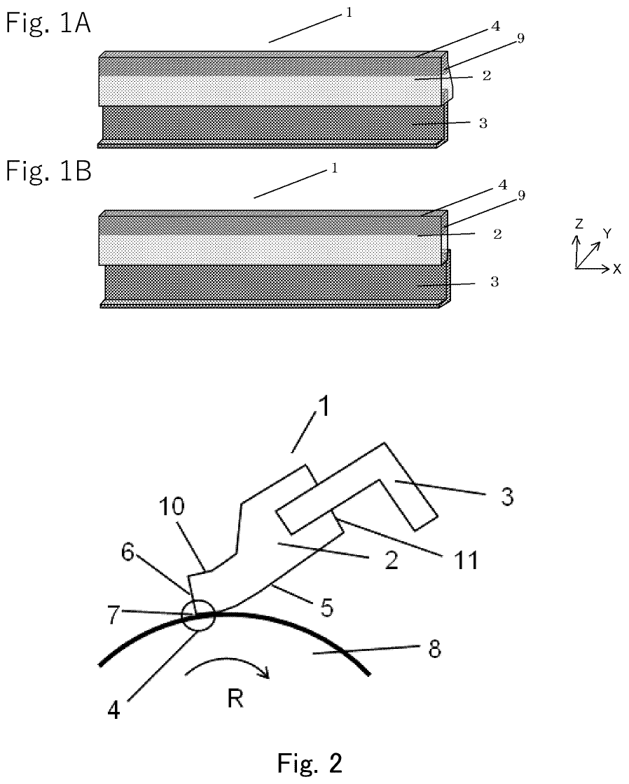

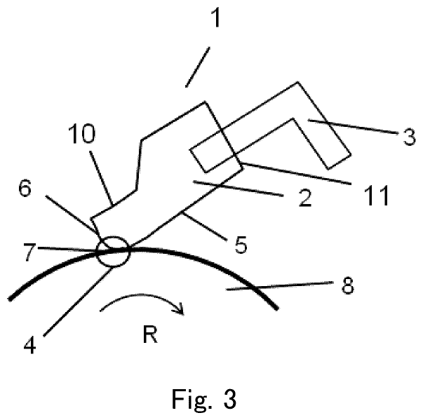

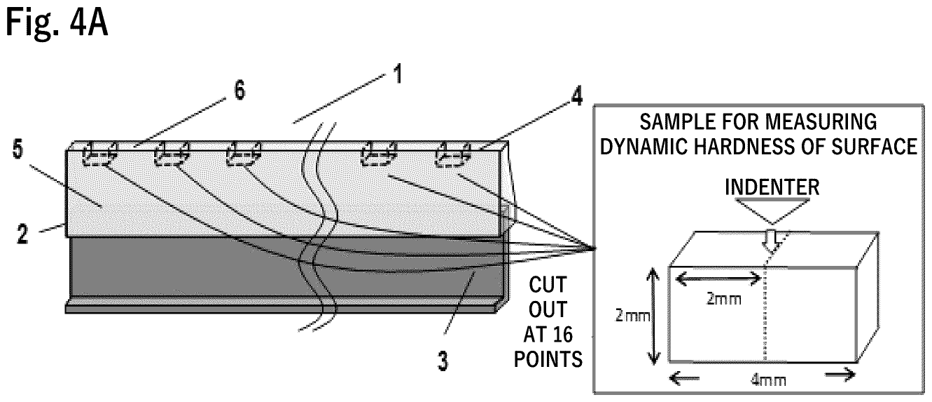

FIG. 1, FIG. 2 and FIG. 3 show an example of a cleaning blade.

FIG. 1 are schematic diagrams showing a configuration of a cleaning blade. The cleaning blade includes an elastic member 2 and a support member 3 that supports the elastic member 2. Here, the elastic member has a first surface at a free end portion of the elastic member and a second surface that constitutes an edge together with the first surface.

In the elastic member, either or both of the first surface and the second surface forming the edge that is brought into contact with the cleaning target member are preferably a cured surface that comes into contact with the cleaning target member. In order to realize improvement in cleaning performance, it is more preferable that a cured region be formed in at least one surface of the first surface and the second surface on both sides of the edge of the cleaning blade that is brought into contact with the cleaning target member which is in contact with the cleaning target member and the inside in the vicinity of the surface. In FIG. 1, the “longitudinal direction” of the cleaning blade is the X direction, and the “lateral direction” and the “thickness direction” are the Z direction and the Y direction, respectively.

In the cleaning blade, the “free end” of the elastic member is the end of the elastic member opposite to the end supported by the support member. In addition, the “free end portion” of the elastic member is the free end and its vicinity. The “edge” refers to a contact region of the cleaning blade that is brought into contact with the cleaning target member, and is a ridge part formed by the first surface and the second surface intersecting each other. In addition, the “first surface” is, for example, a lower surface 5 or a vertical surface 6 of the elastic member in FIG. 2, and the “second surface” is, for example, a vertical surface 6 or a lower surface 5 of the elastic member in FIG. 2. Hereinafter, the lower surface 5 will be referred to as the first surface and the vertical surface 6 will be referred to as the second surface. Hereinafter, the free end of the elastic member and its vicinity will be referred to as the “tip part” of the elastic member or the “tip part” of the cleaning blade.

FIG. 1A shows an example of a cleaning blade in which the elastic member 2 and the support member 3 are integrally molded. The cleaning blade of this example can be obtained by disposing a support member in a mold, then injecting a raw material composition such as a polyurethane elastomer into the mold, heating, reacting and curing it, and removing the mold. After the mold is removed, as necessary, the tip part of the free end of the elastic member in the Z direction and both ends of the elastic member in the X direction can be cut. When a step of forming a cured region at the free end portion of the elastic member is provided, this step may be performed before cutting or after cutting. Thereby, the cleaning blade in which the elastic member 2 and the support member 3 are integrated can be obtained.

FIG. 1B shows an example of an adhesive type cleaning blade obtained by separately molding a sheet for the elastic member, then cutting it into strips to form the elastic member 2, and adhering the elastic member to the support member 3 with an adhesive or the like. Here, a step of forming a cured region 4 at the free end portion of the elastic member may be performed before or after the elastic member is adhered to the support member.

The length of the cleaning blade in the longitudinal direction is not particularly limited, and is, for example, preferably 100 to 500 mm and more preferably 120 to 400 mm.

More specifically, for example, when the cleaning blade according to one aspect of the present disclosure is a cleaning blade of an electrophotographic image forming apparatus that can convey A4-size paper in the horizontal direction (landscape orientation), the length is preferably the entire width of the A4-size paper in the horizontal direction, that is, at least 297 mm or more. In this case, the upper limit of the length is not particularly limited, and is preferably, for example, 350 mm or less, in order to reduce the size of the housing of the electrophotographic image forming apparatus. In addition, when the cleaning blade according to one aspect of the present disclosure is a cleaning blade of an electrophotographic image forming apparatus that can convey A3-size paper in the horizontal direction, the length is preferably the entire width of the A3-size paper in the horizontal direction, that is, 420 mm or more. In this case, the upper limit of the length is not particularly limited, and is preferably, for example, 480 mm or less, in order to reduce the size of the housing of the electrophotographic image forming apparatus. That is, for example, it is preferably 297 to 350 mm, and particularly preferably 420 to 480 mm.

Here, when the cleaning blade according to one aspect of the present disclosure is used in an electrophotographic image forming apparatus that can convey a larger-sized recording material, the length thereof in the longitudinal direction is not limited to the above.

### Support Member

The material constituting the support member of the cleaning blade is not particularly limited, and examples thereof include the following materials. Metal materials such as steel plate, a stainless steel plate, a galvanized steel sheet, and a chromium-free steel plate, and resin materials such as 6-nylon and 6,6-nylon.

In addition, the shape and structure of the support member are not particularly limited. For example, as shown in FIG. 2 and the like, one end of the elastic member of the cleaning blade is supported by the support member.

### Elastic Member

### Depth (Distance) of Cured Region

The elastic member has a region where the dynamic hardness decreases from the edge toward the inside of the elastic member when the dynamic hardness is measured at measurement positions 10 μm away from the edge on a straight line that bisects the angle of the edge in a cross section perpendicular to the longitudinal direction of the elastic member. In addition, in the region where the dynamic hardness decreases, the distance between the edge and the measurement position positioned inside the elastic member when the amount by which the dynamic hardness decreases at two adjacent measurement positions becomes 0.04 or less for the first time is L.

The means for providing such a region in the elastic member is not particularly limited, and examples thereof include a method of providing a cured region formed by impregnating a free end portion of a precursor of an elastic member with a curable composition and then curing the curable composition. Here, the precursor of the elastic member is a member before being impregnated with the curable composition (hereinafter simply referred to as a “precursor”).

Here, the dynamic hardness used as the hardness of the elastic member is a hardness with which the cured region can be measured with higher sensitivity. Therefore, in the measurement at 10 μm intervals, in the region where the dynamic hardness decreases, the distance L between the edge and the measurement position positioned inside the elastic member when the amount by which the dynamic hardness decreases at two adjacent measurement positions becomes 0.04 or less for the first time can be regarded as the boundary between the region where the hardness is increased due to the formation of the cured region and the region which is not impregnated with the curable composition and where the hardness is not increased. That is, the distance L can also be defined as the distance (depth) from the edge of the elastic member to the tip of the interior thereof where the curing treatment is applied.

When the electrophotographic image forming apparatus operates, the state in which the cleaning blade comes into contact with the cleaning target member becomes a state in which the tip part of a free end portion 4 is slightly warped as shown in FIG. 3. The amount of the elastic member warped in this case is thought to be affected by the contact orientation of the entire cleaning blade including the contact region. That is, when the distance L is small, since the region where the hardness is not increased is closer to the contact region, it is easier to form the contact orientation in which the entire elastic member is wrapped. Therefore, it becomes easier to perform an operation when the amount of warpage is relatively large. On the other hand, when the distance L is large, since the vicinity of the contact region is formed of only the cured region, it is difficult to form the contact orientation in which the entire elastic member is wrapped. Therefore, it becomes easier to perform an operation when the amount of warpage is relatively small.

For the above reason, the distance L is preferably 500 μm or less, and more preferably 300 μm or less. When the distance L is set to 500 μm or less, the damping performance of the elastic member can be maintained better. In addition, the lower limit of the distance L is not particularly limited, and is preferably 20 μm or more, and more preferably 40 μm or more because it is possible to more easily secure the contact nip width and exhibit better cleaning performance. For example, the range of the distance L is preferably 20 to 500 μm and particularly preferably 40 to 300 μm.

In the elastic member according to one aspect of the present disclosure, the coefficient of variation of the distance L in the longitudinal direction is small. Specifically, the coefficient of variation of the distance L in the longitudinal direction of the elastic member is 0.28 or less. The coefficient of variation of the distance L is preferably 0.25 or less. The lower limit of the coefficient of variation of the distance L is not particularly limited, and is usually 0.00 or more, and may be 0.02 or more, or 0.04 or more. For example, the range of the distance L is preferably 0.00 to 0.28, particularly preferably 0.02 to 0.28, and still more preferably 0.04 to 0.25.

It is thought that, when the coefficient of variation of the distance L in the longitudinal direction is within the above range, the amount of warpage of the elastic member in the longitudinal direction can be made uniform. The inventors found that, when the region where the amount of warpage is large and the region where the amount of warpage is small coexist in the longitudinal direction of the elastic member, it takes time for the electrophotographic image forming apparatus to start an image forming operation from the resting state and for the contact state of the elastic member against the cleaning target member to become stable. They found that, when the contact state is unstable, at the boundary between the area where the amount of warpage is large and the area where the amount of warpage is small, the cleaning blade is unable to apply a sufficient contact force to the cleaning target member, and causes the toner to slip therethrough.

In addition, they found that, even when the electrophotographic image forming apparatus stops the image forming operation, if the coefficient of variation of the distance L in the longitudinal direction of the elastic member is large, the region where the amount of warpage is large and the region where the amount of warpage is small coexist in the longitudinal direction of the elastic member, and at the boundary between the area where the amount of warpage is large and the area where the amount of warpage is small, a necessary contact force cannot be applied, which causes the toner to slip through.

A method of measuring the coefficient of variation of the distance L in the longitudinal direction of the elastic member will be described below.

The inventors found that, in order to prevent the state in which the region where the amount of warpage is large and the region where the amount of warpage is small exist in the longitudinal direction, it is effective to make the depth of the cured region uniform in the longitudinal direction of the cleaning blade and the coefficient of variation of the distance L within the above range.

As at least one method of obtaining an elastic member in which the coefficient of variation of the distance L is within the above range, for example, a method in which at least one surface of a polyurethane-containing precursor selected from the group consisting of a surface corresponding to the first surface and a surface corresponding to the second surface of the elastic member is impregnated with a curable composition, and the curable composition is cured may be exemplified. Here, in the above method, as the precursor, it is preferable to use a polyurethane-containing precursor in which the length of the soft segments present between crosslinking points is uniform.

That is, the elastic member is preferably a cured product obtained by impregnating at least a part of at least one surface of the precursor of the elastic member selected from the group consisting of a surface corresponding to the first surface and a surface corresponding to the second surface of the elastic member with a curable composition and curing the curable composition.

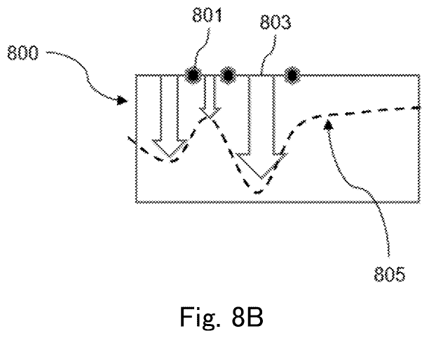

The curable composition penetrates into the precursor through gaps in the polyurethane polymer chains in the precursor, for example, gaps between crosslinking points. In this case, by making the lengths of soft segments between crosslinking points uniform, the penetration distance of the curable composition from the surface of the precursor can be made uniform. That is, as schematically shown in FIG. 8A, if the distance of soft segment portions between crosslinking points 801 of a polyurethane in a precursor 807 is uniform, when the precursor is impregnated with a curable composition 803 from the surface, an impregnation tip 805 of the curable composition 803 inside the precursor is uniform in the longitudinal direction. That is, the coefficient of variation of the distance L tends to be small.

On the other hand, as shown in FIG. 8B, when a precursor 800 in which the length of the soft segments between the crosslinking points 801 is non-uniform is impregnated with the curable composition 803 from the surface, the impregnation tip 805 is non-uniform in the longitudinal direction. That is, the coefficient of variation of the distance L tends to be large.

The cured region-forming material contained in the curable composition tends to aggregate around crystal components in the elastic member in the precursor due to hydrogen bonds or the like. Accordingly, the cured region-forming material impregnated into the precursor inhibits impregnation when the material is impregnated near the crystal component. As a result, when a cured region in which the impregnation depth is large, such as the distance L exceeding 20 μm, is formed, the coefficient of variation of the distance L tends to be large.

Due to the impregnation mechanism described above, the coefficient of variation of the distance L can be reduced depending on characteristics of the precursor.

### Hardness of Cured Region

As described above, the elastic member has a region where the dynamic hardness decreases from the edge toward the inside of the elastic member when the dynamic hardness is measured at measurement positions 10 μm away from the edge on a straight line that bisects the angle of the edge in a cross section perpendicular to the longitudinal direction of the elastic member. Here, the maximum value of the dynamic hardnesses at the measurement positions is DHmax (kgf/m²). In this case, the coefficient of variation of DHmax in the longitudinal direction of the elastic member is 0.20 or less. In addition, a smaller coefficient of variation is preferable, and 0.18 or less is more preferable. The lower limit is not particularly limited, and is usually 0.00 or more, and may be 0.02 or more or 0.04 or more. For example, it is preferably 0.00 to 0.20, 0.02 to 0.20, or 0.04 to 0.18.

The means for setting the coefficient of variation of DHmax in the longitudinal direction of the elastic member to be within the above range is not particularly limited, and examples thereof include forming a cured region in a precursor into which the curable composition easily penetrates. As described above, examples of such precursors include polyurethanes with high molecular mobility of soft segments and hard segments. As another example, a precursor in which the distance between crosslinking points of the soft segments is uniform and the number of nurates and crystals is small is subjected to an impregnation treatment using a curable composition.

As described above, in order to achieve the effects of the present disclosure, it is effective to make the dynamic hardness of the elastic member in the longitudinal direction uniform and the impregnation depth uniform. When the coefficient of variation of the dynamic hardness in the longitudinal direction is large, that is, when the variation of the dynamic hardness in the longitudinal direction is large, it is difficult to obtain the effects of the present disclosure. Therefore, it is preferable that the coefficient of variation of DHmax in the longitudinal direction of the elastic member be within the above range.

Specifically, when the coefficient of variation of DHmax is large, even if the coefficient of variation of the distance L in the longitudinal direction of the elastic member is small, the region where the distortion of the contact orientation is large and the region where the distortion of the contact orientation is small may coexist in the longitudinal direction of the elastic member. As a result, when the electrophotographic image forming apparatus starts an image forming operation from the resting state, it takes time for the contact orientation of the cleaning blade against the cleaning target member to become stable and for the warped state of the elastic member to become stable. Here, when the warped state is unstable, at the boundary between the area where the distortion is large and the area where the distortion is small in the longitudinal direction of the elastic member, a necessary contact force cannot be applied, which causes the toner to slip through.

In addition, when the maximum value DHmax of the dynamic hardness is small, since the amount of deformation of the elastic member increases, the entire elastic member has a bent contact orientation. When the maximum value DHmax of the dynamic hardness is large, since the amount of deformation of the elastic member is small, the entire elastic member has a contact orientation with little deflection.

That is, the average value of the maximum value DHmax of the dynamic hardness in the longitudinal direction of the elastic member is preferably 0.26 to 3.00 kgf/m², and more preferably 0.28 to 2.82 kgf/m².

### Method of Measuring Dynamic Hardness

The dynamic hardness is measured by the following method. As the measurement machine, “Shimadzu dynamic ultra micro hardness tester DUH-W211S” (commercially available from Shimadzu Corporation) is used. As the indenter, a 115° triangular pyramid indenter is used, and the dynamic hardness is determined by the following calculation formula.

$$dynamic hardness ( kgf / {m}^{2} ) : DH = α \times P / {D}^{2}$$

In the formula, α indicates a constant depending on the shape of the indenter, P indicates a test force (mN), and D indicates a level of the indenter penetrated into a sample (indentation depth) (μm).

Measurement conditions are as follows.
α: 3.8584
P: 1.0 mN
load rate: 0.03 mN/sec
maintenance time: 5 seconds
measurement environment: a temperature of 23° C. and a relative humidity of 55%
aging of measurement sample: left in an environment at a temperature of 23° C. and a relative humidity of 55% for 6 hours or longer.

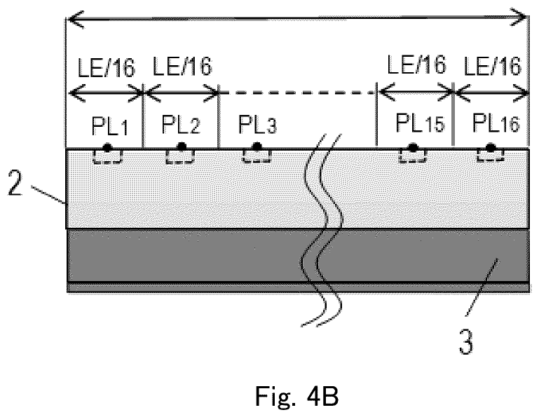

A method of preparing a measurement sample is as follows. When the length of the elastic member in the longitudinal direction is LE, the measurement samples are cut out from the midpoints (16 points, PL₁, PL₂, . . . , PL₁₆) of 16 line segments with the length LE/16 obtained by dividing the elastic member into 16 equal parts in the longitudinal direction, with sizes of 4 mm in the longitudinal direction (2 mm in both longitudinal directions from the midpoint), 2 mm from an edge 7 in the lateral direction and 2 mm in the thickness direction (refer to FIG. 4A and FIG. 4B).

The dynamic hardness of the elastic member is measured by disposing the sample so that the indenter vertically hits the surface (the first surface and the second surface) of the measurement sample at a position 2 mm away from the end in the longitudinal direction and a position from 100 μm to 500 μm away from the edge in the lateral direction or the thickness direction. An enlarged view of FIG. 4A is a view in which the sample is disposed so that the indenter vertically hits the second surface of the sample.

When the dynamic hardness is measured at measurement positions 10 μm away from the edge on a straight line that bisects the angle of the edge in a cross section perpendicular to the longitudinal direction of the elastic member, the presence of a region where the dynamic hardness decreases from the edge toward the inside of the elastic member is measured by the following procedure.

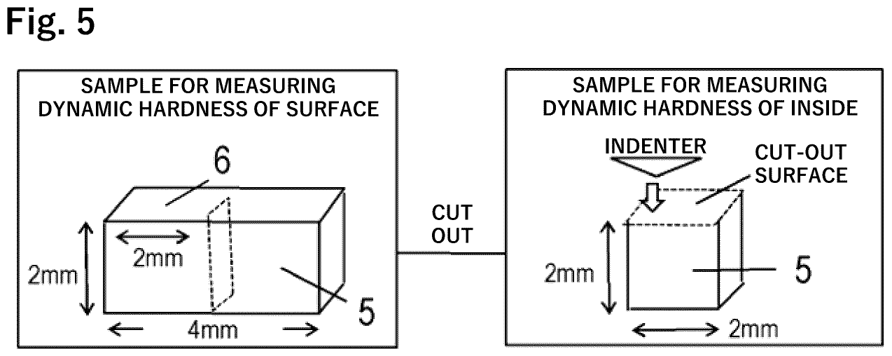

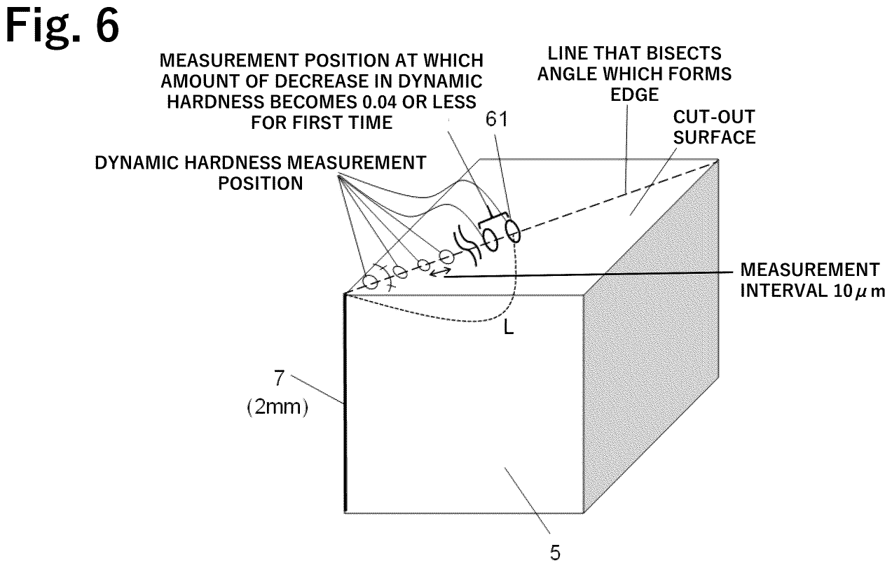

16 cut-out measurement samples are cut at a position of 2 mm in the longitudinal direction, and the measurement sample is disposed so that the indenter vertically hits the cut surface (refer to FIG. 5). The measurement positions are positions on a straight line that bisects the angle of the edge and are at intervals of 10 μm from the edge (refer to FIG. 6). Measurement is performed at these positions in sequence, and measurement is performed to a measurement position at which the amount by which the dynamic hardness decreases at two adjacent measurement positions becomes 0.04 or less for the first time. Here, the presence of a region where the dynamic hardness decreases from the edge toward the inside of the elastic member is confirmed. In addition, the distance between the edge and the measurement position positioned inside the elastic member when the amount by which the dynamic hardness decreases at two adjacent measurement positions becomes 0.04 or less for the first time is defined as the distance L. In addition, the maximum value of the dynamic hardnesses at the measurement positions is DHmax.

The above measurement is performed on 16 measurement samples, and the coefficient of variation of the distance L in the longitudinal direction of the elastic member and the coefficient of variation of the maximum value DHmax of the dynamic hardness in the longitudinal direction of the elastic member are calculated. Here, the coefficient of variation is calculated by the following Formula (1).

$$coefficient of variation = standard deviation / average value \qquad ( 1 )$$

Examples of materials constituting the precursor of the elastic member of the cleaning blade include the following materials. That is, the elastic member may contain the following materials.

Polyurethanes such as polyurethane elastomers, and ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluoro rubber, silicone rubber, epichlorohydrin rubber, NBR hydride, polysulfide rubber and the like. Among these, it is preferable to contain a polyurethane, and it is more preferable that the polyurethane be a polyurethane elastomer composed of hard segments and soft segments. As the polyurethane elastomer, a polyester urethane elastomer is more preferable because it has excellent mechanical properties.

The polyurethane elastomer is a material obtained mainly from raw materials such as polyisocyanate, polyol, chain extenders, catalysts and other additives.

Hereinafter, these raw materials will be described in detail.

As the polyisocyanate, a compound having two or more isocyanate groups in the molecule may be exemplified, and examples thereof include the following: 4,4′-diphenylmethane diisocyanate (4,4′-MDI), polymethylene polyphenylene polyisocyanate (polymeric MDI), 2,4-tolylene diisocyanate (2,4-TDI), 2,6-tolylene diisocyanate (2,6-TDI), xylenediisocyanate (XDI), 1,5-naphthylene diisocyanate (1,5-NDI), p-phenylene diisocyanate (PPDI), hexamethylene diisocyanate (HDI), isophorone diisocyanate (IPDI), 4,4′-dicyclohexylmethane diisocyanate (hydrogenated MDI), tetramethylxylene diisocyanate (TMXDI), carbodiimide-modified MDI, and polymethylene phenyl polyisocyanate (PAPI).

Among these, 4,4′-MDI is preferable because a polyurethane elastomer having excellent mechanical properties is obtained.

Examples of polyols include the following:
polyester polyols such as polyethylene adipate polyol, polybutylene adipate polyol, polyhexylene adipate polyol, (polyethylene/polypropylene) adipate polyol, (polyethylene/polybutylene) adipate polyol, and (polyethylene/polyneopentylene) adipate polyol; polycaprolactone-based polyols obtained by ring-opening polymerization of caprolactone; polyether polyols such as polyethylene glycol, polypropylene glycol, and polytetramethylene glycol; and polycarbonate diol. These may be used alone or two or more thereof may be used in combination.

Among the polyols, a polyester polyol using adipate is preferable because a polyurethane elastomer having excellent mechanical properties is obtained. A polyester polyol using butylene adipate is more preferable.

As the chain extender, one that can extend polyurethane elastomer chains, for example, glycols and tri- or higher polyhydric alcohols, can be used.

Examples of glycols include the following:

ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexanedimethanol, xylylene glycol (terephthalyl alcohol), and triethylene glycol.

Examples of tri- or higher polyhydric alcohols include trimethylolpropane, glycerin, pentaerythritol, and sorbitol. These may be used alone or two or more thereof may be used in combination. These tri- or higher polyhydric alcohols are preferably used as crosslinking agents. Among the polyhydric alcohols, trimethylolpropane is more preferable.

As the catalyst, catalysts generally used for curing polyurethane elastomers can be used. For example, tertiary amine catalysts may be exemplified, and specific examples thereof include the following. Amino alcohols such as dimethylethanolamine, N,N,N′-trimethylaminopropylethanolamine, and N,N′-dimethylhexanolamine; trialkylamines such as triethylamine; tetraalkyldiamines such as N,N,N′,N′-tetramethyl-1,3-butanediamine; triethylenediamine, piperazine-based compounds, and triazine-based compounds. In addition, metal organic acid salts such as potassium acetate, and potassium alkaline octylate can be used. In addition, metal catalysts usually used for urethanization, for example, dibutyltin dilaurate, can also be used. These may be used alone or two or more thereof may be used in combination.

As the catalyst, N,N′-dimethylhexanolamine is preferable. Examples of commercially available catalysts include Kaolizer No. 25 (product name, commercially available from Kao Corporation). The catalyst is suitable for promoting urethanization over nurate formation. In addition, since it has an OH group at the end, it functions as a catalyst while also participating in the reaction and being incorporated internally, it is possible to reduce the possibility of chemical attack due to exudation. In addition, it is preferable because it also has favorable reactivity. In addition, an ethylene glycol solution of potassium acetate is also preferable. Examples of commercially available products include POLYCAT46 (product name, commercially available from Air Products Japan, K.K.).

For example, the polyurethane elastomer is preferably a reaction product of a mixture containing at least at least one polyol selected from the group consisting of polyester polyol and polyether polyol, a tri- or higher polyhydric alcohol, and 4,4′-MDI.

For example, the polyurethane elastomer is preferably a reaction product of a mixture containing at least at least one polyol selected from the group consisting of polyester polyol and polyether polyol, a polyisocyanate including 4,4′-MDI, and a tri- or higher polyhydric alcohol.

In the constituent components of the mixture as a raw material for the polyurethane elastomer, the content of the polyol is preferably 50 to 80 mass %, and more preferably 55 to 70 mass %.

In the constituent components of the mixture as a raw material for the polyurethane elastomer, the content of the polyisocyanate is preferably 15 to 50 mass %, and more preferably 25 to 40 mass %.

In the constituent components of the mixture as a raw material for the polyurethane elastomer, the content of the tri- or higher polyhydric alcohol is preferably 3 to 15 mass %, and more preferably 5 to 10 mass %.

As necessary, additives such as a pigment, a plasticizer, a waterproofing agent, an antioxidant, a UV absorbing agent, and a light stabilizer can be added to the raw material constituting the precursor.

Although details will be described below, when the precursor contains a polyurethane, if the molecular mobility of soft segments and hard segments is higher, during the production process of the elastic member, the curable composition tends to easily penetrate into the precursor. As a result, the coefficient of variation of DHmax in the longitudinal direction of the elastic member and the coefficient of variation of the distance L in the longitudinal direction of the elastic member are easily adjusted to desired values.

Here, in the present disclosure, the hard segment is a component with low molecular mobility at or near crosslinking points such as crystal components formed by aggregating urethane bonds, nurate bonds, polymeric MDI, and trimethylolpropane. In addition, the soft segment is a segment with high molecular mobility between crosslinking points.

The molecular mobility of hard segments decreases when the amount of rigid components such as nurate bonds in the polyurethane, crosslinking portions derived from polymeric MDI, and the crystal structure formed by the interaction between soft segments increases and increases when the crosslinking points are made flexible.

Accordingly, in order to increase the molecular mobility of hard segments, it is preferable to minimize the use of polymeric MDI as a raw material for the polyurethane, and it is particularly preferable to avoid using it altogether. In addition, in order to prevent the formation of crystal components due to interaction of the soft segment portion, it is preferable to use trimethylolpropane (TMP) as the crosslinking component. When a crosslinked structure derived from TMP is introduced into the polyurethane, the soft segment portions present between the crosslinked structures are less likely to interact with each other due to the steric hindrance of the crosslinked structure derived from TMP. As a result, the formation of the crystal structure (crystal component) due to the interaction between soft segments, that is, the formation of hard segments, is inhibited.

Here, since trimethylolpropane has a methylene framework adjacent to a hydroxyl group, a crosslinked structure with a flexible molecular structure is formed. As a result, the polyurethane according to one aspect of the present disclosure is likely to have a higher molecular mobility of hard segments than a polyurethane having a rigid crosslinked structure derived from polymeric MDI.

The molecular mobility of soft segments and hard segments can be evaluated by measuring the spin-spin relaxation time T2 (lateral relaxation time) in pulse NMR using a measurement sample to be described below.

In pulse NMR measurement of a polyurethane elastomer in an environment at 50° C., when the polyurethane elastomer is separated into two components, a hard segment and a soft segment, the spin-spin relaxation time (T2_{L}) of the soft segment is preferably 250 to 320 μs.

When the molecular mobility of soft segments is high, since it takes time for relaxation, the spin-spin relaxation time (T2_{L}) of the soft segment increases.

The spin-spin relaxation time T2 is measured by a solid echo method using a pulse NMR device.

The pulse NMR device is a device for evaluating the mobility of polymer molecules such as rubber based on the mobility (relaxation time) of hydrogen atoms in the molecular chains, and in the present embodiment, the solid echo method is used as the sequence. The solid echo method itself using a pulse NMR device is not particularly limited, and known methods can be used.

When the spin-spin relaxation time T2 of the elastic member of the cleaning blade is measured by pulse NMR measurement, a T2 relaxation curve (free induction decay curve) is obtained.

A specific measurement means will be described below.

When T2_{L} is less than 250 μs, the molecular mobility of soft segments is not sufficient, and the curable composition does not easily penetrate into the precursor. On the other hand, when T2_{L} exceeds 320 μs, the tip of the elastic member is more likely to move excessively due to high molecular mobility of soft segments, which makes it easier for the toner and external additives to slip through.

T2_{L} is more preferably 260 μs or more and still more preferably 270 μs or more. In addition, T2_{L} is more preferably 310 μs or less and still more preferably 300 μs or less. For example, T2_{L} is preferably in a range of 260 to 310 μs or 270 to 300 μs.

T2_{L}, which is an index of the molecular mobility of soft segments, can be controlled by the crosslinking density. When the crosslinking density is higher, the molecular weight between crosslinking points is smaller, the size of the space in which the soft segments can move freely is smaller, and thus the molecular mobility decreases. As a result, T2_{L} decreases. In addition, making the lengths of soft segments between crosslinking points uniform is also effective to minimizing the molecular mobility of soft segments.

In order to obtain a polyurethane in which the distance between crosslinking points is short and the length between crosslinking points is uniform, for example, it is preferable to set the number average molecular weight of the prepolymer as a raw material for the polyurethane to be within a range of 8,000 to 12,000 and to minimize the use of a chain extender such as 1,4-butanediol, and it is particularly preferable not to use any chain extender at all. That is, the polyurethane is preferably a reaction product of a mixture containing a prepolymer having a number average molecular weight of 8,000 to 12,000 and a curing agent.

Here, the urethane prepolymer is a polymer obtained by reacting a polyol with a polyisocyanate. The urethane prepolymer has at least one isocyanate group and has a polyether structure. Hereinafter, the urethane prepolymer will be simply referred to as a prepolymer.

In addition, the number average molecular weight of the prepolymer can be adjusted by changing the number average molecular weight of the polyol used as a raw material for the prepolymer or the type of the polyisocyanate.

Here, an example of conditions for measuring the number average molecular weight of the prepolymer is as follows.
Device: HLC-8320GPC (product name, commercially available from Tosoh Corporation)
Column: TSKgel SuperMultiporeHZ-N (product name, commercially available from Tosoh Corporation; 4.6 mmID×15 cm)
Eluent: THF
Flow rate: 0.35 mL/min
Sample: 0.5 wt % THF solution
Injection amount: 10 μL
Detector: RI
Temperature: 40° C.
Standard substance: polystyrene

In addition, in pulse NMR measurement of a polyurethane elastomer in an environment at 50° C., when the polyurethane elastomer is separated into two components, a hard segment and a soft segment, the T2 relaxation time (T2_{S}) of the hard segment is preferably 52 to 85 μs.

When T2_{S} is 52 μs or more, the molecular mobility of hard segments is sufficient, and the curable composition tends to more easily penetrate into the precursor. In addition, when T2_{S} is 85 μs or less, the molecular mobility of hard segments is not too high, the tip of the elastic member can be prevented from moving excessively, and the toner and external additives can be more effectively prevented from slipping through.

### Molecular Mobility of Hard Segment

The molecular mobility of hard segments is affected by rigid components in the molecule. The rigid components are nurates and crystals, and when the amount of these components is reduced, the molecular mobility of hard segments can increase. Therefore, it is preferable to minimize the number of nurate bonds and make urethane rich. Details are as follows.

In FT-IR measurement of a polyurethane elastomer using diamond as an ATR crystal, the value of the ratio of the peak intensity at 1,415 cm⁻¹ to the peak intensity at 1,538 cm⁻¹ (the peak intensity at 1,415 cm⁻¹/the peak intensity at 1,538 cm⁻¹) is preferably 0.50 to 0.65.

In FT-IR analysis of a polyurethane elastomer using diamond as an ATR crystal, the peak at 1,415 cm⁻¹ is a peak corresponding to the isocyanurate ring. On the other hand, the peak at 1,538 cm⁻¹ is a peak corresponding to the NH bending angle of the urethane bond. That is, when the value of the peak intensity at 1,415 cm⁻¹/the peak intensity at 1,538 cm⁻¹ is in a range of 0.50 to 0.65, this indicates that the number of nurate bonds in the polyurethane elastomer is small.

When the value of the peak intensity at 1,415 cm⁻¹/the peak intensity at 1,538 cm⁻¹ (peak intensity ratio) is larger than 0.65, this indicates that there are a large number of nurate bonds in the polyurethane elastomer. Therefore, the molecular mobility of hard segments decreases due to rigidity of the nurate, and the curable composition does not easily penetrate into the precursor. On the other hand, when the value of the peak intensity at 1,415 cm⁻¹/the peak intensity at 1,538 cm⁻¹ is smaller than 0.50, since the molecular mobility of hard segments tends to become too large conversely, the value is preferably 0.50 to 0.65. The value of the peak intensity at 1,415 cm⁻¹/the peak intensity at 1,538 cm⁻¹ is preferably 0.53 to 0.65.

In order to set the value of the peak intensity at 1,415 cm⁻¹/the peak intensity at 1,538 cm⁻¹ to be within the above specific range, a method of reducing the number of nurate bonds and making urethane rich may be used. Specific examples thereof include using a urethanization catalyst while avoiding a catalyst that promotes nurate formation, making the mixing ratio of —NCO and —OH in the prepolymer closer to 1, and setting the reaction temperature when prepolymer materials are reacted to 100° C. or lower.

The polyurethane may contain a rigid structure such as polymeric MDI as a constituent component. Details are as follows.

The elastic member preferably has a plate shape, at least on the free end side, having a main surface (for example, a first surface) that faces the cleaning target member and a tip surface (for example, a second surface) that forms an edge together with the main surface. Here, the polyurethane elastomer contained in the precursor of the elastic member is heated to 1,000° C. at a ramp rate of 10° C./s using a direct sample introduction type mass spectrometer that heats and vaporizes a sample containing the polyurethane elastomer in an ionization chamber and ionizes sample molecules. The amount of all ions detected as a result is M1, and the integrated intensity of the peaks in the extracted ion thermogram derived from the polymeric MDI and corresponding to an m/z value range of 380.5 to 381.5 is M2. In this case, M2/M1 is preferably less than 0.0010.

As a method of determining, from an elastic member, physical properties of the polyurethane elastomer contained in the precursor of the elastic member, for example, the following methods may be exemplified. That is, on a straight line that bisects the angle of an edge formed by the first surface and the second surface of the elastic member, a portion of the elastic member that is positioned inward from the edge by a distance L is not impregnated with the curable composition. Therefore, the polyurethane elastomer contained in this portion can be regarded as equivalent to the polyurethane elastomer contained in the precursor.

Thus, a measurement sample is prepared by removing the region where the dynamic hardness decreases (cured region) from the elastic member, the following measurement is performed using the measurement sample, and thus M2/M1 of the polyurethane elastomer contained in the precursor can be measured.

When a measurement sample is prepared, the region where the dynamic hardness decreases extends to a depth of a distance L from the edge on a straight line that bisects the edge of the elastic member. Therefore, one obtained by removing a region from each surface of the elastic member to, for example, at least a depth of L×1.4, can be used as a measurement sample. Here, for example, the surface obtained by removing a region from the tip surface of the elastic member to a depth of L×1.4 is referred to as a surface corresponding to the tip surface of the elastic member, and the surface obtained by removing a region from the main surface of the elastic member to a depth of L×1.4 is referred to as a surface corresponding to the main surface of the elastic member. In this case, a surface corresponding to the tip surface of the elastic member and a surface corresponding to the main surface of the elastic member form an edge A.

In the measurement sample, it is assumed that a third line segment is drawn on the surface corresponding to the tip surface of the elastic member parallel to the edge A at a distance of 0.5 mm from the edge A. Here, the length of the third line segment is L′, and points ⅛L′, ½L′, and ⅞L′ from one end side on the third line segment are P0′, P1′, and P2′, respectively. The samples sampled at P0′, P1′ and P2′ are heated to 1,000° C. at a ramp rate of 10° C./s using a direct sample introduction type mass spectrometer that heats and vaporizes a sample in an ionization chamber and ionizes sample molecules. When the amount of all ions detected obtained as a result is M1, and the integrated intensity of the peaks in the extracted ion thermogram derived from the polymeric MDI and corresponding to an m/z value range of 380.5 to 381.5 is M2, M2/M1 of the polyurethane elastomer can be calculated.

As the isocyanate, it is preferable to use 4,4′-MDI which has high reactivity and in which two isocyanate groups have equal reactivity. On the other hand, as described above, it is preferable to minimize the use of polymeric MDI, which is a trifunctional MDI, and it is particularly preferable to avoid using it altogether. Specifically, M2/M1 is preferably less than 0.0010. When M2/M1 is within the above specific range, the molecular mobility of soft segments becomes sufficient, and the curable composition easily penetrates into the precursor.

M2/M1 is more preferably 0.0009 or less. A smaller M2/M1 is preferable, and the lower limit of M2/M1 is not particularly limited, and is preferably 0.0000 or more.

When M2/M1 is 0.001 or more, the molecular mobility of soft segments is not sufficient due to rigidity of the polymeric MDI, and the curable composition does not easily penetrate into the precursor.

In addition, in order to increase the molecular mobility of hard segments, it is preferable to minimize the amount of crystal structures. Specifically, it is preferable to minimize the amount of materials that tend to form crystal structures such as 1,4-butanediol and to make the crosslinking agent, such as trimethylolpropane, rich. The crosslinking agent such as trimethylolpropane makes it easier to maintain the distance between urethane bonds and makes it difficult for the crystal structure to form.

### Molecular Mobility of Soft Segment

The molecular mobility of soft segments is easily affected by the distance between crosslinking points and the structure between crosslinking points. Therefore, for example, the molecular mobility of soft segments can be reduced by shortening the distance between crosslinking points and increasing the ester group concentration of the polyol.

Examples of methods of shortening the distance between crosslinking points include increasing the concentration of the crosslinking agent in the raw material composition of the elastic member. The distance between crosslinking points depends on the ester group concentration and is preferably about 6,000 to 9,000 g/mol. The concentration of the crosslinking agent in the raw material composition of the elastic member is preferably 0.30 to 0.70 mmol/g, more preferably 0.40 to 0.61 mmol/g, and still more preferably 0.50 to 0.60 mmol/g in consideration of the molecular mobility of hard segments.

The method of calculating the concentration of the crosslinking agent will be described below. For example, quantification can be performed by pyrolysis GC/MS.

The polyhydric alcohol is detected by pyrolysis GC/MS. Measurement conditions are as follows.

### Device

Pyrolysis device: EGA/PY-3030D (product name, commercially available from Frontier Laboratories Ltd.)
Gas chromatography device: TRACE1310 gas chromatography (product name, Thermo Fisher Scientific)
Mass spectrometer: ISQLT (product name, Thermo Fisher Scientific)
Pyrolysis temperature: 500° C.
GC column: inner diameter 0.25 mm×30 m stainless steel capillary column
stationary phase 5% phenylpolydimethylsiloxane
Heating conditions: maintained at 50° C. for 3 minutes, and heated to 300° C. at 8° C./min
MS condition: mass number range m/z=10 to 650
Scan speed: 1 second/scan

The type of polyhydric alcohols is qualified by GC/MS. A calibration curve is created using GC analysis of qualified polyhydric alcohol types with known concentrations, quantification is performed based on the GC peak area ratio, and the concentration of the crosslinking agent in the raw material composition is calculated.

In addition, it is preferable that the distance between crosslinking points of soft segments be as uniform as possible. When the distance between crosslinking points is non-uniform, the molecular mobility of the entire precursor tends to vary. For example, some components with high molecular mobility may cause the molecular mobility of soft segments to be excessively high, some components with low molecular mobility may cause the molecular mobility of soft segments to be insufficient, and the curable composition may not easily penetrate into the precursor. Therefore, in order to secure sufficient molecular mobility of soft segments, it is preferable to have few rigid components, many crosslinks, and uniform distances between crosslinking points. The method of making the distance between crosslinking points uniform is not limited, and examples thereof include a method of preparing a polyurethane by a prepolymer method using a prepolymer having as uniform a molecular weight distribution as possible. It is preferable to use a simple material composition with a uniform molecular weight so that the molecular weight distribution is uniform and it is preferable to minimize the use of a chain extender such as glycol, which tends to make the molecular weight distribution non-uniform.

In this case, the number average molecular weight of the prepolymer is preferably 8,000 to 12,000. The molecular weight can be analyzed by GPC using the above method.

In the elastic member, the angle of the edge formed by the first surface and the second surface is not particularly limited, and is usually about 85 to 95 degrees.

In addition, the International Rubber Hardness Degree (IRHD) of the elastic member is preferably 60 degrees or more and more preferably 65 degrees or more. The upper limit is not particularly limited, and is may be 90 degrees or less or 85 degrees or less. It is preferably, for example, 60 to 90 degrees, or 65 to 85 degrees.

### Cured Region Forming Location

When a cured region is formed in the elastic member, in order to improve cleaning performance, the cured region forming location at the free end portion of the elastic member is preferably on at least one surface of the first surface and the second surface brought into contact with a cleaning target member 8 and the inside in the vicinity of the surface. When the cleaning target member is a photosensitive member, the image-forming region on the surface of the photosensitive member is brought into contact with the edge of the cleaning blade and cleaned. In this case, the non-cleaning member rotates in the R direction.

The cured region may be additionally formed in a surface other than the first surface and the second surface at the tip part of the elastic member, that is, the surface that faces the first surface (surface indicated by reference numeral 10 in FIG. 2), and two end surfaces of the elastic member in the longitudinal direction (surfaces indicated by reference numeral 9 in FIG. 1). In this case, the rigidity of both end surfaces of the elastic member can be improved, and the amount of warpage of the cleaning blade can be further reduced.

### Method of Forming Cured Region

The method of forming a cured region in the elastic member is not particularly limited, and examples thereof include applying a curable composition containing a cured region-forming material to a region where high hardness is desired and curing it. That is, it is preferable that the elastic member be impregnated with a cured product of the curable composition. The curable composition is used after being diluted with a dilution solvent as necessary, and can be applied by a known means such as dipping, spraying, using a dispenser, brush application, or roller application. As the cured region-forming material, an isocyanate compound to be described below can be used. In addition, the curable composition preferably contains a polymerization initiator.

In order to form a cured region inside the elastic member rather than on the surface, it is necessary to sufficiently impregnate the precursor of the elastic member with a curable composition containing a cured region-forming material (such as an isocyanate compound). Since impregnation is promoted by reducing the viscosity of the curable composition, it is effective to dilute or heat the curable composition, or use these in combination. The material temperature is preferably 40° C. or higher and preferably 120° C. or lower. The temperature is preferably, for example, 40 to 120° C.

The method of impregnating the precursor with the curable composition and then curing the curable composition is not particularly limited, and examples thereof include a heat treatment and a treatment using ultraviolet light emission. Among these, a heat treatment is preferable in order to sufficiently form the cured region inside the elastic member. Heat treatment conditions will be described below.

When a treatment is performed by emitting ultraviolet light, a light source that generates ultraviolet light is used in the cured region forming step. Particularly, the wavelength of the maximum emission peak is preferably near 254 nm, for example, in a range of 254±1 nm. When there are a plurality of ultraviolet light emission peaks, one of them is preferably near 254 nm.

The intensity of light emitted from a light source is not particularly limited, and values measured using a spectroradiometer (USR-40V/D commercially available from Ushio Inc.) and an accumulated UV intensity meter (UIT-150-A, UVD-S254, VUV-S172, VUV-S365, commercially available from Ushio Inc.) can be used. In addition, the cumulative light amount of ultraviolet light may be appropriately selected according to the degree of formation of the cured region. The cumulative light amount can be adjusted by the emission time of light from a light source, the output of the light source, the distance from the light source, or the like, and may be determined such that, for example, a desired cumulative light amount such as 100 J/m² is obtained.

The cumulative light amount of ultraviolet light emitted to a conductive member can be calculated by, for example, the following method.

$$ultraviolet light cumulative light amount ( mJ / {cm}^{2} ) = ultraviolet light intensity ( mW / {cm}^{2} ) \times emission time ( sec )$$

As light sources that emit ultraviolet light, for example, a high-pressure mercury lamp and a low-pressure mercury lamp can be suitably used. These light sources are preferable because they can stably emit ultraviolet light with a suitable wavelength with little attenuation over the emission distance and can easily emit light to the entire surface uniformly.

Hereinafter, an example of the method of forming a cured region will be described using an example using an isocyanate compound as the cured region-forming material.

In order to form a cured region inside the elastic member rather than on the surface, it is preferable to apply the curable composition to the precursor of the elastic member, then remove the excess curable composition, and perform a heat treatment. According to the heat treatment, the viscosity of the curable composition present on the surface of the precursor can be reduced and penetration and diffusion into the precursor can be promoted. The heat treatment method is not particularly limited, and examples thereof include a method of passing a sample through a heating furnace and a method of blowing heated air. Examples of heating furnaces include a radiation type heating furnace and a circulating air type heating furnace, and examples of devices for generating heated air include a hot air heater and a far infrared heater.

When a high temperature and/or a long time are set in heating conditions, the cured region becomes wider, and the cured region with the highest hardness transitions to a position further inward from the surface of the precursor. In the heating conditions, it is preferable to heat at least the surface of the tip part of the precursor at a temperature of 80° C. or higher for 3 minutes or longer. Even if the tip part of the precursor is continuously heated at a temperature of lower than 80° C., the viscosity of the isocyanate compound does not drop to a level of viscosity required for diffusion on the precursor, and thus the diffusion rate tends to slow. As a result, a large amount of the isocyanate compound remains on the surface of the precursor, and the hardness of the surface of the elastic member tends to be the highest. The atmosphere in the heating furnace is preferably set to a temperature higher than 80° C. in order to set the surface temperature of the tip part of the precursor to 80° C. or higher.

However, the temperature and time of this heat treatment vary depending on the amount of the cured region-forming material impregnated into the precursor. Specifically, in conditions in which the cured region-forming material is sufficiently impregnated into the precursor (such as a temperature of the cured region-forming material being 90° C.), a cured region can be formed inside the elastic member rather than the surface under heating furnace conditions of 100° C. for 10 minutes.

However, in conditions in which the cured region-forming material is not sufficiently impregnated into the precursor (such as a temperature of the curable composition being 60° C.), under heating furnace conditions of 100° C. for 10 minutes, it is difficult for a cured region to be formed inside the elastic member, and the surface is likely to have the highest hardness. In this case, the heating furnace conditions are preferably 130° C. for 10 minutes or longer.

In addition, in order to make it easier for a cured region to be formed inside the elastic member rather than the surface, in the raw material composition of the elastic member, it is effective to adjust the mixing ratio of the prepolymer and the curing agent. As a specific mixing ratio, it is preferable to perform mixing so that the molar ratio (a value) of the hydroxyl group (—OH) to the isocyanate group (—NCO) is 0.40 to 1.00, and it is more preferable to perform mixing so that the molar ratio is 0.45 to 0.95.

Regarding the state of the precursor of the elastic member when the cured region is formed, it is preferable that a larger amount of unreacted isocyanate groups be present inside the precursor. Since isocyanate groups present on the surface of and inside the precursor react with the isocyanate compound, which is a cured region-forming material, when more unreacted isocyanate groups are present inside the precursor, the inside of the elastic member is more likely to have a high hardness.

In addition, the amount of residual isocyanate after molding tends to gradually decreases over time. Therefore, the formation of the cured region is preferably performed within 6 hours after the elastic member is produced. The amount of residual isocyanate can be controlled by the raw material composition ratio of the elastic member and the time after the elastic member is produced.

Regarding the measurement of the amount of residual isocyanate on the surface, for example, infrared spectroscopy (IR) can be used for measurement. From the IR spectrum obtained by measuring the elastic member, the NCO peak of isocyanurate (near 2,260 cm⁻¹ to 2,270 cm⁻¹) and the aromatic ring peak of isocyanate (near 1,600 cm⁻¹) are assigned, and the value ratio (A/B) of the absorbance A of NCO to the absorbance B of the aromatic ring is an index of the amount of residual isocyanate. In order to easily form a region with a high hardness in the interior than on the surface, the A/B value, which is an index of the amount of residual isocyanate, is preferably 0.1 or more on the surface of the elastic member. The upper limit is not particularly limited, and may be, for example, 1.5 or less. It is preferably, for example, 0.1 to 1.5.

In order to form a cured region on the surface rather than the inside of the elastic member, it is preferable to apply the curable composition to the precursor, then remove the excess curable composition, and perform air-drying or a heat treatment at a low temperature. As the heating conditions, it is preferable to heat the tip part of the precursor at a temperature of lower than 80° C.

### Cured Region-Forming Material

The cured region-forming material is not particularly limited as long as it can cure the precursor of the elastic member or it can form a cured region on the surface of the elastic member, and examples thereof include compounds having crosslinkable functional groups such as isocyanate compounds and (meth)acrylate. The material that forms the cured region may be used after being diluted with a solvent or the like. The solvent used for dilution is not particularly limited as long as it dissolves materials used, and examples thereof include methanol, ethanol, toluene, xylene, butyl acetate, methyl isobutyl ketone, and methyl ethyl ketone.

When (meth)acrylate is used as a cured region-forming material, the (meth)acrylate is not particularly limited, and examples thereof include alkyl (meth)acrylates such as methyl (meth)acrylate and ethyl (meth)acrylate; isocyanate (meth)acrylates having an isocyanate group; hydroxy (meth)acrylates having a hydroxy group such as 2-hydroxy-3-methacrylpropyl acrylate and hydroxy alkyl (meth)acrylate; and silicone (meth)acrylates such as acrylic group-containing polydimethylsiloxane. Among these, at least one selected from the group consisting of silicone (meth)acrylate and hydroxy (meth)acrylate is preferable.

When the constituent material of the elastic member is a polyester urethane elastomer, as the cured region-forming material, it is more preferable to use an isocyanate compound, which is a constituent material of the polyester urethane elastomer, in consideration of compatibility with the elastic member and impregnation into the elastic member.

As the isocyanate compound which is the material that forms the cured region, a compound having one or more isocyanate groups in the molecule can be used.

As the isocyanate compound having one isocyanate group in the molecule, aliphatic monoisocyanate such as octadecyl isocyanate (ODI) and aromatic monoisocyanates such as phenyl isocyanate (PHI) can be used.

As the isocyanate compound having two isocyanate groups in the molecule, usually, those used for producing a polyurethane resin can be used, and specifically, the following components may be exemplified. 2,4-tolylene diisocyanate (2,4-TDI), 2,6-tolylene diisocyanate (2,6-TDI), 4,4′-diphenylmethane diisocyanate (MDI), m-phenylene diisocyanate (MPDI), tetramethylene diisocyanate (TMDI), hexamethylene diisocyanate (HDI), isophorone diisocyanate (IPDI), dicyclohexylmethane diisocyanate (hydrogenated MDI), ortho-toluidine diisocyanate (TODI), naphthylene diisocyanate (NDI), xylylene diisocyanate (XDI), paraphenylene diisocyanate (PDI), lysine diisocyanate methyl ester (LDI), dimethyl diisocyanate (DDI), and the like.

As the isocyanate compound having three or more isocyanate groups in the molecule, for example, 4,4′,4″-triphenylmethane triisocyanate, 2,4,4′-biphenyl triisocyanate, 2,4,4′-diphenylmethane triisocyanate, polymethylene polyphenylene polyisocyanate (polymeric MDI) and the like can be used.

In addition, as the isocyanate compound having two or more isocyanate groups, modified products and multimers thereof can also be used. Examples of modified products include carbodiimide-modified MDI. In addition, blocked isocyanates using a blocking agent can also be used.

Among these, in order to efficiently increase the hardness of the cured region, MDI having a high crystallinity, that is, a symmetry structure, is preferable. In addition, MDI containing a modified product is more preferable in terms of workability because it is a liquid at room temperature. As the MDI containing a modified product, a carbodiimide-modified MDI is preferable.

### Method of Producing Cleaning Blade

### Production of Cleaning Blade Precursor

The method of producing a cleaning blade is not particularly limited, and any suitable method may be selected from among known methods.

In addition, as the method of producing an elastic member, a suitable method may be selected from among known methods such as a mold molding method and a centrifugal molding method. When the elastic member contains a polyurethane, for example the following method may be used.

In a cleaning blade mold having a cavity for forming an elastic member, a support member with an adhesive applied to a contact portion with the elastic member is disposed. On the other hand, a prepolymer formed by partially polymerizing a polyisocyanate and a polyol, and a curing agent containing a polyol, a chain extender, a catalyst, and other additives are put into a casting machine, and mixed and stirred at a certain ratio in a mixing chamber to obtain a raw material composition of the polyurethane elastomer.

A polyol may be added to the curing agent. In order to make the distance between crosslinking points uniform, it is preferable that the number average molecular weight of the polyol added to the curing agent be the same as the number average molecular weight of the polyol used in the prepolymer. For example, the difference in the number average molecular weight between the two polyols is preferably 500 or less, 200 or less, or 100 or less.

In addition, the raw material composition of the polyurethane elastomer is preferably prepared by a prepolymer method using a prepolymer having as uniform a molecular weight distribution as possible. First, it is preferable to have a step of reacting a polyol with a polyisocyanate to obtain a prepolymer. The NCO content in the prepolymer is not particularly limited, and is preferably 3.00 to 15.00 mass %, and more preferably 6.00 to 10.00 mass %.

The raw material composition is injected into the mold, a cured molded product (elastic member) is formed on the adhesive-coated surface of the support member, and the mold is removed after reaction and curing. As necessary, the elastic member can be appropriately cut to a predetermined size and to secure the edge dimensional accuracy of the contact region of the elastic member, and thus a cleaning blade precursor in which the support member and the elastic member are integrally molded can be produced.

In addition, when the elastic member is produced by a centrifugal molding machine, a raw material composition of the polyurethane elastomer obtained by mixing and stirring a prepolymer formed by partially polymerizing a polyisocyanate and a polyol, and a curing agent containing a polyol, a chain extender, a catalyst, and other additives is put into a rotating drum to obtain a polyurethane elastomer sheet. This polyurethane elastomer sheet is cut to a predetermined size and to secure the edge dimensional accuracy of the contact region of the elastic member. The polyurethane elastomer sheet (elastic member) thus obtained can be attached to the support member coated with the adhesive to produce a cleaning blade precursor.

### Formation of Cured Region

The cured region can be formed by the above method. That is, the cured region can be formed by applying a curable composition to a region where high hardness is desired and curing it. For example, the cured region can be formed by the following method.

First, the curable composition is applied to the first surface and the second surface of the free end portion of the elastic member contained in the cleaning blade precursor. Next, the free end portion of the elastic member is heated, for example, at a temperature of 80° C. or higher for 3 minutes or longer. Thereby, the cured region can be formed in the surface and the inside of the tip part of the elastic member.

When it is necessary to cut the elastic member in order to form an edge on the cleaning blade, which is brought into contact with the cleaning target member, the cured region may be formed before or after the cutting. Here, in the case of centrifugal molding, the cured region can be formed before being bonded to the support member.

As described above, the cleaning blade can be obtained.

### Process Cartridge and Electrophotographic Image Forming Apparatus

The cleaning blade can be used after being incorporated into the process cartridge that is detachable from the electrophotographic image forming apparatus. Specifically, for example, in a process cartridge including an image bearing member as a cleaning target member and a cleaning blade disposed so that it is able to clean the surface of the image bearing member, the cleaning blade according to this aspect can be used as the cleaning blade. The process cartridge contributes to stable formation of high-quality electrophotographs.

The electrophotographic image forming apparatus includes an image bearing member such as a photosensitive member and a cleaning blade disposed so that it is able to clean the surface of the image bearing member, and the cleaning blade is the cleaning blade according to this aspect. The electrophotographic image forming apparatus can stably form high-quality electrophotographic images.

### EXAMPLES

The present disclosure will be described below with reference to production examples, examples and comparative examples, but the present disclosure is not limited to these examples. Reagents or industrial chemicals were used as raw materials other that those shown in examples and comparative examples.

### Example 1

### 1. Support Member

A galvanized steel sheet with a thickness of 1.6 mm was prepared and processed to obtain a support member with an L-shaped cross section as indicated by reference numeral 3 in FIG. 2.

Here, a single urethane-metal layer type adhesive (product name; Chemlok 219, commercially available from LORD Corporation) was applied to the area of the support member with which the elastic member came into contact.

### 2. Preparation of Raw Materials for Elastic Member

### Prepolymer

As the isocyanate, 332.0 g of 4,4′-diphenylmethane diisocyanate (product name: Millionate MT, commercially available from Tosoh Corporation) (hereinafter referred to as 4,4′-MDI)

As the polyol, a butylene adipate polyester polyol having a number average molecular weight of 2,500 (product name: NIPPOLLAN 3027, commercially available from Tosoh Corporation) (hereinafter referred to as PBA2500.). 668.0 g

The materials were reacted at 80° C. for 3 hours to obtain a prepolymer having an NCO content of 9.00 mass %.

### Curing Agent

Trimethylolpropane (commercially available from Tokyo Chemical Industry Co., Ltd.) (hereinafter referred to as TMP) 91.1 g

N,N′-dimethylhexanolamine (product name: Kaolizer No. 25, commercially available from Kao Corporation) (hereinafter referred to as No. 25) 0.30 g

The materials were mixed to prepare a curing agent.

A curing agent was added to the obtained prepolymer and mixed to obtain a polyurethane elastomer composition.

### 3. Integral Molding of Support Member and Elastic Member

The adhesive-coated area of the support member was disposed so that it protruded into the cavity of a mold for molding the cleaning blade. A polyurethane elastomer composition was injected into the mold for molding the cleaning blade and cured at 130° C. for 5 minutes, and the mold was then removed to obtain a component in which the elastic member (polyurethane) and the support member were integrally molded.

The mold to which a release agent A was applied before the polyurethane elastomer composition was injected was used. As the release agent A, a mixture containing 5.06 g of ELEMENT14 PDMS 1000-JC (product name, commercially available from Momentive Performance Materials Japan LLC), 6.19 g of ELEMENT14 PDMS 10K-JC (product name, commercially available from Momentive Performance Materials Japan LLC), 3.75 g of SR1000 (product name, commercially available from Momentive Performance Materials Japan LLC), and 85 g of EXXSOL DSP145/160 was used.

The free end side of the polyurethane elastomer of this integrally molded component was appropriately cut to obtain a plate-shaped elastic member having a main surface (first surface) and a tip surface (second surface) that forms an edge together with the main surface. The angle of the edge was set to 90 degrees, and the distances of the elastic member in the lateral direction, the thickness direction and the longitudinal direction were set to 7.5 mm, 1.8 mm, and 240 mm, respectively. Hereinafter, the cleaning blade precursor obtained here will be referred to as a precursor A.

### 4. Formation of Cured Region

A carbodiimide-modified MDI (product name; Millionate MTL, commercially available from Tosoh Corporation) was prepared as a cured region-forming material. The cured region-forming material was heated to 80° C., the elastic member was immersed in the material for 20 seconds so that the other five surfaces (the first surface, the second surface, the surface that faces the first surface, and both end surfaces in the longitudinal direction), excluding the surface (reference numeral 11 in FIG. 2) supported by the support member, were immersed, and the cured region-forming material was applied to the surfaces. Then, the cured region-forming material on the surface of the elastic member was wiped off using a sponge soaked in butyl acetate as a solvent.

Next, the cured region-forming material impregnated into the elastic member was heated in an electric furnace at a temperature of 40° C. for 40 minutes so that it additionally diffused into the elastic member and was cured. In this manner, a cleaning blade 1 in which cured regions were formed in five surfaces of the elastic member and the inside below these five surfaces was obtained. Here, the cured region was formed 1 hour after the elastic member was molded (hereinafter referred to as a treatment condition A).

The obtained cleaning blade was evaluated by the following method.

### 1. Measurement of Distance L of Cured Region and Maximum Value DHmax of Dynamic Hardness

The dynamic hardness was measured by the following method. As the measurement machine, “Shimadzu dynamic ultra micro hardness tester DUH-W211S” (commercially available from Shimadzu Corporation) was used. As the indenter, a 115° triangular pyramid indenter was used, and the dynamic hardness was determined by the following calculation formula.

$$dynamic hardness ( kgf / {m}^{2} ) : DH = α \times P / {D}^{2}$$

In the formula, α indicates a constant depending on the shape of the indenter, P indicates a test force (mN), and D indicates a level of the indenter penetrated into a sample (indentation depth) (μm).

Measurement conditions are as follows.
α: 3.8584
P: 1.0 mN
Load rate: 0.03 mN/sec
Maintenance time: 5 seconds
Measurement environment: a temperature of 23° C. and a relative humidity of 55%
Aging of measurement sample: left in an environment at a temperature of 23° C. and a relative humidity of 55% for 6 hours or longer.

A method of preparing a measurement sample is as follows. When the length of the elastic member in the longitudinal direction was LE, the measurement samples were cut out using a razor blade from the midpoints (16 points, PL₁, PL₂, . . . , PL₁₆) of 16 line segments with the length LE/16 obtained by dividing the elastic member into 16 equal parts in the longitudinal direction, with sizes of 4 mm in the longitudinal direction (2 mm in both longitudinal directions from the midpoint), 2 mm from an edge 7 in the lateral direction and 2 mm in the thickness direction (refer to FIG. 4A and FIG. 4B).

The dynamic hardness of the elastic member was measured by disposing the sample so that the indenter vertically hit the surface (the first surface and the second surface) of the measurement sample at a position 2 mm away from the end in the longitudinal direction and a position from 100 μm to 500 μm away from the edge in the lateral direction or the thickness direction. An enlarged view of FIG. 4A is a view in which the sample is disposed so that the indenter vertically hits the second surface of the sample.

When the dynamic hardness was measured at measurement positions 10 μm away from the edge on a straight line that bisects the angle of the edge in a cross section perpendicular to the longitudinal direction of the elastic member, the presence of a region where the dynamic hardness decreased from the edge toward the inside of the elastic member was measured by the following procedure.

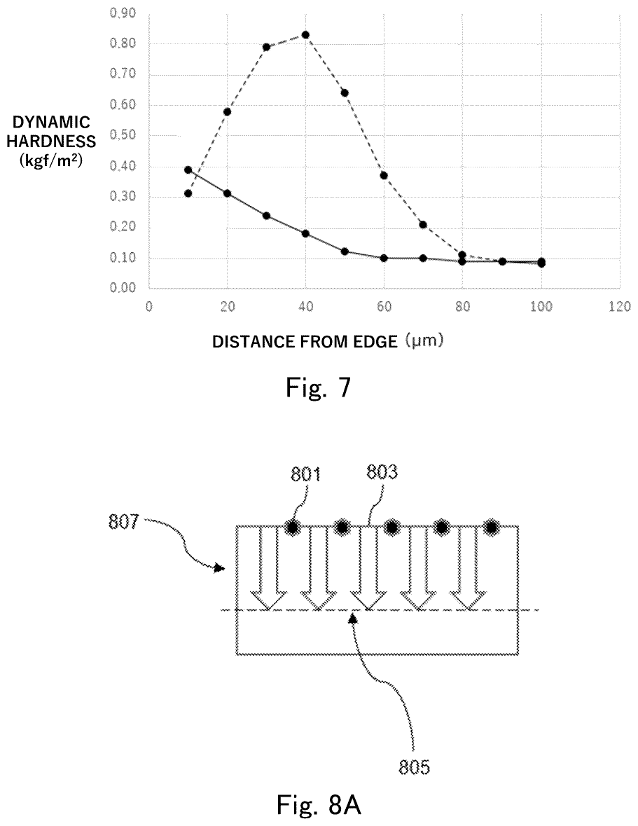

16 cut-out samples were cut using a razor blade at a position of 2 mm in the longitudinal direction, and the sample was disposed so that the indenter vertically hit the cut surface (refer to FIG. 5). The measurement positions were positions on a straight line that bisects the angle of the edge and are at intervals of 10 μm from the edge (refer to FIG. 6). Measurement was performed at these positions in sequence, and measurement was performed to a measurement position at which the amount by which the dynamic hardness decreased at two adjacent measurement positions became 0.04 or less for the first time. Here, the dynamic hardness at the measurement position closest to the edge was compared with the dynamic hardness at a measurement position positioned closer to the inside of the elastic member than to the measurement position, and the presence of a region where the dynamic hardness decreased from the edge toward the inside of the elastic member was confirmed. In addition, the distance between the edge and a measurement position 61 positioned inside the elastic member when the amount by which the dynamic hardness decreased at two adjacent measurement positions became 0.04 or less for the first time was defined as the distance L. In addition, the maximum value of the dynamic hardnesses at the measurement positions is DHmax. The dynamic hardness at each measurement position is shown by the solid line in FIG. 7. In FIG. 7, it was confirmed that there was a region where the dynamic hardness decreased at a position from the edge at a distance of 10 to 80 μm.

The above measurement was performed on 16 measurement samples, and the coefficient of variation of the distance L and the coefficient of variation of the maximum value DHmax of the dynamic hardness were calculated. Here, the coefficient of variation was calculated by the following Formula (1).

$$coefficient of variation = standard deviation / average value \qquad ( 1 )$$

### Method of Removing Cured Region

As described above, the region (cured region) where the dynamic hardness decreased was formed to a depth of the distance L from the edge of the elastic member according to measurement of the dynamic hardness. Thus, before the cured region was formed, that is, in order to measure the physical properties of the urethane elastomer contained in the precursor, the physical properties of the polyurethane elastomer contained in the elastic member were measured at a distance L from the edge on a straight line that bisects the angle of the edge. Specifically, a sample was prepared by removing portions from the surfaces of the elastic member to a depth of 500 μm using a razor blade. This operation was an operation of removing the cured region containing the cured product of the curable composition. When this sample was subjected to the following measurement, it was possible to determine the physical properties of the polyurethane elastomer which has not yet been impregnated with the curable composition, that is, which can be regarded as the same as the polyurethane elastomer contained in the precursor.

The following T2 relaxation time measurement, FT-IR analysis, and M1 and M2 measurement were performed using this sample. Here, among the surfaces of the measurement sample, the surface obtained by removing a region from the first surface of the elastic member to a depth of 500 μm is referred to as a surface corresponding to the first surface of the elastic member, and a surface obtained by removing a region from the second surface of the elastic member to a depth of 500 μm is referred to as the surface corresponding to the second surface of the elastic member. In this case, the surface corresponding to the first surface of the elastic member and the surface corresponding to the second surface of the elastic member formed an edge A′.

### 2. Measurement of T2 Relaxation Time

The spin-spin relaxation time (T2) was measured by the solid echo method in pulse NMR analysis.

Regarding the sample, a measurement sample was cut at measurement positions to be described below and cut into small pieces with a size of 1 mm×1 mm, and 1 g of the pieces was put into a test tube.

Pulse NMR measurement conditions are as follows.
Device: JNM-MU25 (commercially available from JEOL Ltd.)
Condition: solid echo method
Measurement environment: 50° C.
Number of measurements: 128

The measurement results were separated into two components (soft segment and hard segment) by the least squares method in software bundled in the device, and respective spin-spin relaxation times (T2_{L} and T2_{S}) were obtained.

In the present disclosure, the obtained T2 relaxation curve was separated into two components, a hard segment and a soft segment, according to the length of the relaxation time. Specifically, the T2 relaxation curve was separated into two components, a hard segment and a soft segment, by curve fitting using the following formula, and the spin-spin relaxation time (T2_{L}) of the soft segment and the spin-spin relaxation time (T2_{S}) of the hard segment were calculated.

$$M ( t ) = {A}_{L} [ - {( \frac{t}{T {2}_{L}} )}^{mi} ] + {A}_{S} exp [ - {( \frac{t}{T {2}_{S}} )}^{mi} ]$$

M(t): macroscopic magnetization
A_{L}: intensity at t=0 of the long relaxation time component (soft segment)
T2_{L}: T2 relaxation time of the long relaxation time component (soft segment)
A_{S}: intensity at t=0 of the short relaxation time component (hard segment)
T2_{S}: T2 relaxation time of the short relaxation time component (hard segment)
mi: Weibull coefficient
Measurement position: the length of the edge A′ was L₀, measurement was performed at positions ⅛L₀, ½L₀, and ⅞L₀ from one end side on the edge A′, and the average values thereof are shown in Table 1-1 and Table 1-2.

### 3. FT-IR Analysis of Elastic Member by ATR Method

The values of the peak intensity at 1,415 cm⁻¹ and the peak intensity at 1,538 cm⁻¹ of the elastic member were measured by the ATR method using FT-IR.

Regarding the sample, measurement samples cut out at measurement positions to be described below were used.

The FT-IR measurement conditions are as follows.
Device: FT/IR-4700 (commercially available from JASCO Corporation)
Measurement mode: ATR method (crystal: diamond)
Cumulative number of measurements: 64
Measurement position: the length of the edge A′ was L₀, and measurement was performed at positions ⅛L₀, ½L₀, and ⅞L₀ from one end side on the edge A′.

From the obtained peak intensities, the value of the peak intensity at 1,415 cm⁻¹/the peak intensity at 1,538 cm⁻¹ was calculated, and the arithmetic mean values thereof are shown in Table 1-1 and Table 1-2.

### 4. Method of Measuring M1 and M2

M1 and M2 were measured by a direct sample introduction method (DI method) in which the sample was directly introduced into an ion source without passing through gas chromatography (GC).

POLARIS Q (commercially available from Thermo Fisher Scientific) was used as the device, and a Direct Exposure Probe (DEP) was used.

In the measurement sample, assuming that a line segment was drawn on the surface corresponding to the tip surface of the elastic member parallel to the edge A′ at a distance of 0.5 mm from the edge A′, the length of the line segment was L′, and points ⅛L′, ½L′, and ⅞L′ from one end side on the line segment were P0′, P1′, and P2′, respectively. The polyurethane was scrapped off from P0′, P1′ and P2′ using a biocutter.

0.1 μg of the sample to be sampled at each of P0′, P1′ and P2′ was fixed to a filament positioned at the tip of the probe and directly inserted into the ionization chamber. Then, the sample was rapidly heated at a certain ramp rate (10° C./s) from room temperature to 1,000° C., and the vaporized gas was detected by a mass spectrometer.

As the amount M1 of all ions detected, the total integrated intensity of all peaks in the obtained total ion current thermogram was used.

The integrated intensity of the peaks of the extracted ion thermogram derived from the polymeric MDI and corresponding to an m/z value range of 380.5 to 381.5 was M2, and M2/M1 was calculated. Here, the arithmetic mean value of the values obtained at P0′, P1′ and P2′ was used as the value of M2/M1 in the present disclosure.

### 5. Evaluation of Cleaning Performance

In a cyan cartridge of a color laser beam printer (product name; HP LaserJet Enterprise Color M555dn, commercially available from Hewlett-Packard Company), a cleaning blade 1 was incorporated as a cleaning blade of a photosensitive drum which was a cleaning target member. In addition, the toner in the developing machine of the cyan cartridge was completely replaced with a toner 1 to be described below.

Next, in a low temperature and low humidity environment (a temperature of 15° C. and a relative humidity of 10%), images were formed on 13,000 sheets, which is the number of printable sheets (hereinafter referred to as “normal evaluation”). In the image forming conditions, a 10-second operation pause time was set whenever one image sheet was output.

In addition, the developing machine was replaced with a new black cartridge developing machine, and images were formed on another 13,000 sheets, which is the number of printable sheets (hereinafter referred to as “double-yield evaluation”). In addition, the evaluation was performed while sucking out the waste toner from a hole made in the rear surface of the cartridge at an appropriate time. The obtained images were ranked in terms of performance based on the following evaluation criteria. The evaluation results are shown in Table 2.
A: No image defects (streaks on the image) caused by the cleaning blade occurred in either the normal evaluation or the double-yield evaluation.
B: Image defects (streaks on the image) caused by the cleaning blade did not occur in the normal evaluation but occurred slightly in the double-yield evaluation, but the defects were not problematic in practical use.
C: Image defects (streaks on the image) caused by the cleaning blade occurred in both the normal evaluation and the double-yield evaluation.

### 6. Method of Producing Toner 1

In the following, unless otherwise specified, “parts” are all based on mass.

### Step of Preparing Aqueous Medium 1

650.0 parts of deionized water was put into a reaction container including a stirrer, a thermometer, and a reflux tube, 14.0 parts of sodium phosphate (12-hydrate, commercially available from Rasa Industries, Ltd.) was added, and the mixture was kept at 65° C. for 1.0 hour while purging with nitrogen. Using a T.K. homomixer (commercially available from Tokushu Kika Kogyo Co., Ltd.), while stirring at 15,000 rpm, a calcium chloride aqueous solution in which 9.2 parts of calcium chloride (dihydrate) was dissolved in 10.0 parts of deionized water was added at once to prepare an aqueous medium containing a dispersion stabilizer. In addition, 10 mass % hydrochloric acid was added to the aqueous medium and the pH was adjusted to 5.0 to obtain an aqueous medium 1.

### Step of Preparing Polymerizable Monomer Composition

Styrene: 60.0 parts
C.I. pigment blue 15:3: 6.5 parts

The materials were added to an attritor (commercially available from Mitsui Miike Machinery Co., Ltd.), and additionally dispersed using zirconia particles with a diameter of 1.7 mm at 220 rpm for 5.0 hours to prepare a pigment-dispersed solution. The following materials were added to the pigment-dispersed solution.
Styrene: 20.0 parts
n-Butyl acrylate: 20.0 parts
Crosslinking agent (divinylbenzene): 0.3 parts
Saturated polyester resin: 5.0 parts

### Polycondensation Product of Propylene Oxide Modified Bisphenol A (2-mol Adduct) and Terephthalic Acid (a Molar Ratio of 10:12), Glass Transition Temperature Tg=68° C., Weight Average Molecular Weight Mw=10,000, Molecular Weight Distribution Mw/Mn=5.12

Fischer-Tropsch wax (with a melting point of 78° C.): 7.0 parts

These materials were kept at 65° C. and uniformly dissolved and dispersed using a T.K. homomixer (commercially available from Tokushu Kika Kogyo Co., Ltd.) at 500 rpm to prepare a polymerizable monomer composition.

### Granulation Step

While maintaining the temperature of the aqueous medium 1 at 70° C. and the rotational speed of the T.K. homomixer at 15,000 rpm, the polymerizable monomer composition was added to the aqueous medium 1, and 10.0 parts of t-butyl peroxypivalate as a polymerization initiator was added. Granulation was directly performed for 10 minutes while maintaining 15,000 rpm with the stirring device.

### Polymerization and Distillation Step

After the granulation step, the stirrer was replaced with a propeller stirring blade, polymerization was performed for 5.0 hours while stirring at 150 rpm and maintaining 70° C., the temperature was raised to 85° C., and heating was performed for 2.0 hours to cause a polymerization reaction.

Then, the reflux tube of the reaction container was replaced with a cooling tube, the slurry was heated to 100° C., distillation was performed for 6 hours, and unreacted polymerizable monomers were distilled off to obtain a toner base particle-dispersed solution.

### Polymerization of Organosilicon Compound

60.0 parts of deionized water was weighed out into a reaction container including a stirrer and a thermometer, and the pH was adjusted to 4.0 using 10 mass % hydrochloric acid. This was heated while stirring, and the temperature reached 40° C.

Then, 40.0 parts of methyltriethoxysilane as an organosilicon compound was added, and the mixture was stirred for 2 hours or longer to perform hydrolysis. The end point of the hydrolysis was visually checked when oil and water were no longer separated and remained in a single layer, and cooling was performed to obtain a hydrolysis solution containing the organosilicon compound.

The temperature of the obtained toner base particle-dispersed solution was cooled to 55° C., and 25.0 parts of the organosilicon compound hydrolysis solution was then added to initiate polymerization of the organosilicon compound. After the mixture was maintained for 15 minutes without change, the pH was adjusted to 5.5 using a 3.0 mass % sodium bicarbonate aqueous solution. The mixture was maintained at 55° C. for 60 minutes while continuing stirring, the pH was then adjusted to 9.5 using a 3.0 mass % sodium bicarbonate aqueous solution, and the mixture was additionally maintained for 240 minutes to obtain a toner particle-dispersed solution.

### Washing and Drying Step

After the polymerization step was completed, the toner particle-dispersed solution was cooled, hydrochloric acid was added to the toner particle-dispersed solution, the pH was adjusted to 1.5 or less, and the mixture was stirred and left for 1 hour and then subjected to solid-liquid separation using a pressure filter to obtain a toner cake. This was re-slurried using deionized water to make a dispersion solution again, and the mixture was then subjected to solid-liquid separation using the above filter to obtain a toner cake.

The obtained toner cake was dried in a thermostatic chamber at 40° C. and classified for 72 hours to obtain a toner 1.

### Examples 2 to 9 and Comparative Examples 1 to 8

Prepolymers and curing agents were prepared in the same manner as in Example 1 except that formulation materials and amounts thereof were changed as shown in Table 1-1 and Table 1-2, and thereby polyurethane elastomer compositions were obtained. Precursors B to M were obtained using the obtained polyurethane elastomer composition. Cleaning blades were prepared in the same manner as in Example 1 except that the precursors A to M were treated under the conditions shown in Table 2, Table 3 and below, and the obtained cleaning blades were evaluated in the same manner as in Example 1. The dynamic hardness at each measurement point on the straight line that bisects the angle of the edge of the cleaning blade according to Example 3 is indicated by the dotted line in FIG. 7. In FIG. 7, it was confirmed that there was a region where the dynamic hardness decreased at a position from the edge at a distance of 40 to 90 μm.

The evaluation results are shown in Table 1-1, Table 1-2, Table 2 and Table 3. In addition, the cleaning blades obtained in Examples 2 to 9 and Comparative Examples 1 to 8 had the region where the dynamic hardness decreased from the edge toward the inside of the elastic member.

Details of materials used other than those shown in Example 1 are as follows.
Polybutylene adipate polyester polyol having a number average molecular weight of 1,000 (product name: NIPPOLLAN 4009, commercially available from Tosoh Corporation) (hereinafter referred to as PBA1000)
Polybutylene adipate polyester polyol having a number average molecular weight of 2,000 (product name: NIPPOLLAN 4010, commercially available from Tosoh Corporation) (hereinafter referred to as PBA2000)
Polyhexylene adipate polyester polyol having a number average molecular weight of 1,000 (product name: NIPPOLLAN 164, commercially available from Tosoh Corporation) (hereinafter referred to as PHA1000)
Polytetramethylene ether glycol having a number average molecular weight of 1,000 (product name: PTG-1000SN, commercially available from Hodogaya Chemical Co., Ltd.) (hereinafter referred to as PTMG1000)
Polymeric MDI (product name: Millionate MR-400, commercially available from Tosoh Corporation) (hereinafter referred to as pMDI)
1,4-butanediol (commercially available from Tokyo Chemical Industry Co., Ltd.) (hereinafter referred to as 1,4-BD)
POLYCAT46 (commercially available from Air Products Japan, K.K.) (hereinafter referred to as PC46)
TEDA (triethylenediamine) (commercially available from Tosoh Corporation)
K-KAT XK-627 (commercially available from Kusumoto Chemicals, Ltd.) (hereinafter referred to as K-KAT)

TABLE 1-1

| | | | | Precursor | Precursor | Precursor | Precursor | Precursor |
|---|---|---|---|---|---|---|---|---|
| | | | | A | B | C | D | E |
| Formulation | Prepolymer | MDI | Addition amount (g) | 332 | 332 | 350 | 348 | 332 |
| | | pMDI | Addition amount (g) | 0 | 0 | 0 | 0 | 20 |
| | | Polyol | Type | PBA2500 | PBA2500 | PBA2000 | PBA1000 | PBA2500 |
| | | | Addition amount (g) | 668 | 668 | 650 | 652 | 648 |
| | Curing agent | 1,4-BD | Addition amount (g) | 0 | 0 | 0 | 0 | 0 |
| | | TMP | Addition amount (g) | 91.1 | 70.4 | 91.1 | 62.7 | 97.4 |
| | | Polyol | Type | — | PHA1000 | — | — | — |
| | | | Addition amount (g) | 0 | 70.4 | 0 | 0.0 | 0 |
| | | No25 | Addition amount (g) | 0.30 | 0.20 | 0.30 | 0.20 | 0.30 |
| | | PC46 | Addition amount (g) | 0 | 0.06 | 0 | 0 | 0 |
| | | TEDA | Addition amount (g) | 0 | 0 | 0 | 0 | 0 |
| | | K-KAT | Addition amount (g) | 0 | 0 | 0 | 0 | 0 |

| | | | | | | | |
|---|---|---|---|---|---|---|---|
| | Crosslinking agent | mmol/g | 0.62 | 0.46 | 0.62 | 0.44 | 0.65 |
| | concentration | | | | | | |
| pulse NMR | T2L | us | 294 | 320 | 255 | 273 | 280 |
| | T2S | us | 56.0 | 53.3 | 56.4 | 68.4 | 54.5 |
| IR | 1415 cm − 1/1538 cm − 1 | — | 0.56 | 0.64 | 0.55 | 0.53 | 0.54 |
| Mass analysis | M2/M1 | — | 0.0000 | 0.0000 | 0.0000 | 0.0000 | 0.0008 |

| | | | | Precursor | Precursor | Precursor |
|---|---|---|---|---|---|---|
| | | | | F | G | H |
| Formulation | Prepolymer | MDI | Addition amount (g) | 332 | 379 | 371 |
| | | pMDI | Addition amount (g) | 0 | 0 | 0 |
| | | Polyol | Type | PHA2500 | PTMG1000 | PTMG1000 |
| | | | Addition amount (g) | 668 | 621 | 628 |
| | Curing agent | 1,4-BD | Addition amount (g) | 0 | 0 | 0 |
| | | TMP | Addition amount (g) | 91.1 | 75.9 | 68.9 |
| | | Polyol | Type | — | — | PTMG1000 |
| | | | Addition amount (g) | 0 | 0 | 69 |
| | | No25 | Addition amount (g) | 0.30 | 0.20 | 0.40 |
| | | PC46 | Addition amount (g) | 0 | 0 | 0.00 |
| | | TEDA | Addition amount (g) | 0 | 0 | 0 |
| | | K-KAT | Addition amount (g) | 0 | 0 | 0 |

| | | | | | |
|---|---|---|---|---|---|
| | Crosslinking agent | mmol/g | 0.62 | 0.53 | 0.45 |
| | concentration | | | | |
| pulse NMR | T2L | us | 297 | 271 | 294 |
| | T2S | us | 56.4 | 65.2 | 84.5 |
| IR | 1415 cm − 1/1538 cm − 1 | — | 0.56 | 0.57 | 0.56 |
| Mass analysis | M2/M1 | — | 0.0000 | 0.0000 | 0.0000 |

TABLE 1-2

| | | | | Precursor | Precursor | Precursor | Precursor | Precursor |
|---|---|---|---|---|---|---|---|---|
| | | | | I | J | K | L | M |
| Formulation | Prepolymer | MDI | Addition | 363 | 286 | 327 | 343 | 188 |
| | | | amount (g) | | | | | |
| | | pMDI | Addition | 0 | 0 | 0 | 0 | 210 |
| | | | amount (g) | | | | | |
| | | Polyol | Type | PBA2000 | PBA2000 | PBA2500 | PBA1000 | PBA2500 |
| | | | Addition | 637 | 714 | 673 | 657 | 602 |
| | | | amount (g) | | | | | |
| | Curing agent | 1,4-BD | Addition | 0 | 0 | 12.9 | 0 | 0 |
| | | | amount (g) | | | | | |
| | | TMP | Addition | 91.1 | 20.4 | 23.7 | 46.1 | 58.0 |
| | | | amount (g) | | | | | |
| | | Polyol | Type | — | — | PHA1000 | — | PHA1000 |
| | | | Addition | 0 | 0.0 | 167.9 | 0.0 | 328.9 |
| | | | amount (g) | | | | | |
| | | No25 | Addition | 0.27 | 0.00 | 0.35 | 0.17 | 0.53 |
| | | | amount (g) | | | | | |
| | | PC46 | Addition | 0 | 0 | 0 | 0 | 0 |
| | | | amount (g) | | | | | |
| | | TEDA | Addition | 0 | 0.1 | 0 | 0 | 0 |
| | | | amount (g) | | | | | |
| | | K-KAT | Addition | 0 | 0.2 | 0 | 0 | 0 |
| | | | amount (g) | | | | | |

| | | | | | | | |
|---|---|---|---|---|---|---|---|
| | Crosslinking agent | mmol/g | 0.62 | 0.15 | 0.15 | 0.32 | 0.29 |
| | concentration | | | | | | |
| pulse NMR | T2L | us | 255 | 352 | 334 | 270 | 327 |
| | T2S | us | 42.8 | 33.5 | 49.1 | 90.5 | 52.1 |
| IR | 1415 cm − 1/ | — | 0.56 | 0.61 | 0.80 | 0.56 | 0.636 |
| | 1538 cm − 1 | | | | | | |
| Mass | M2/M1 | — | 0.0000 | 0.0000 | 0.0000 | 0.0000 | 0.0120 |
| analysis | | | | | | | |

TABLE 2

| | | | Example | Example | Example | Example | Example | Example | Example | Example | Example |
|---|---|---|---|---|---|---|---|---|---|---|---|
| | | | 1 | 2 | 3 | 4 | 5 | 6 | 7 | 8 | 9 |
| Precursor | | | A | A | B | C | D | E | F | G | H |
| Treatment condition | | | A | B | C | A | D | F | G | D | E |
| Impregnation | Standard | μm | 13 | 81 | 21 | 7 | 14 | 10 | 10 | 11 | 21 |
| depth L | deviation | | | | | | | | | | |
| | Average value | μm | 57 | 342 | 81 | 42 | 75 | 52 | 41 | 61 | 91 |
| | Coefficient | | 0.23 | 0.24 | 0.26 | 0.17 | 0.19 | 0.19 | 0.24 | 0.18 | 0.23 |
| | of variation | | | | | | | | | | |
| Dynamic | Standard | kgf/m² | 0.11 | 0.54 | 0.16 | 0.04 | 0.14 | 0.05 | 0.11 | 0.07 | 0.14 |
| hardness | deviation | | | | | | | | | | |
| peak | Average value | kgf/m² | 0.62 | 2.82 | 0.82 | 0.28 | 0.79 | 0.30 | 0.55 | 0.46 | 0.75 |
| value DHmax | Coefficient | | 0.18 | 0.19 | 0.20 | 0.14 | 0.18 | 0.17 | 0.20 | 0.15 | 0.19 |
| | of variation | | | | | | | | | | |

| | | | | | | | | | |
|---|---|---|---|---|---|---|---|---|---|
| Evaluation | A | A | B | A | A | A | B | A | B |

TABLE 3

| | | | Comparative | Comparative | Comparative | Comparative |
|---|---|---|---|---|---|---|
| | | | Example 1 | Example 2 | Example 3 | Example 4 |
| Precursor | | | I | J | K | K |
| Treatment condition | | | C | A | C | A |
| Impregnation | Standard | μm | 35 | 32 | 26 | 35 |
| depth L | deviation | | | | | |
| | Average value | μm | 104 | 89 | 58 | 74 |
| | Coefficient | | 0.34 | 0.36 | 0.45 | 0.47 |
| | of variation | | | | | |
| Dynamic | Standard | kgf/m² | 0.30 | 0.50 | 0.14 | 0.20 |
| hardness | deviation | | | | | |
| peak value | Average value | kgf/m² | 1.10 | 1.20 | 0.33 | 0.48 |
| DHmax | Coefficient | | 0.27 | 0.42 | 0.43 | 0.42 |
| | of variation | | | | | |
| Evaluation | | | C | C | C | C |
| | | | Comparative | Comparative | Comparative | Comparative |
| | | | Example 5 | Example 6 | Example 7 | Example 8 |
| Precursor | | | K | K | L | M |
| Treatment condition | | | F | G | D | E |
| Impregnation | Standard | μm | 38 | 24 | 25 | 25 |
| depth L | deviation | | | | | |
| | Average value | μm | 81 | 52 | 81 | 84 |
| | Coefficient | | 0.47 | 0.46 | 0.31 | 0.30 |
| | of variation | | | | | |
| Dynamic | Standard | kgf/m² | 0.30 | 0.40 | 0.30 | 0.20 |
| hardness | deviation | | | | | |
| peak value | Average value | kgf/m² | 0.50 | 0.72 | 0.91 | 0.61 |
| DHmax | Coefficient | | 0.60 | 0.56 | 0.33 | 0.33 |
| | of variation | | | | | |

| | | | | |
|---|---|---|---|---|
| Evaluation | C | C | C | C |

In Table 2 and Table 3. treatment conditions B to G are described below.

The treatment condition B was the same as the treatment condition A except that the immersion time of the cured region-forming material was changed to 300 seconds, and the heat treatment time in the electric furnace was changed to 60 minutes.

The treatment condition C was the same as the treatment condition A except that the heat treatment temperature in the electric furnace was changed to 80° C.

In the treatment condition D, the same cured region-forming material as in the treatment condition A was heated to 80° C., the coating amount was set to 20 drops or 18 mg, and coating was performed on the vertical surface (second surface) of the elastic member using a dispenser while moving the elastic member at 100 mm/s. Next, this integrally molded component was left in an environment at a temperature of 25° C. and a relative humidity of 50% for 10 minutes, and then heated in the electric furnace at a temperature of 80° C. for 40 minutes to obtain a cleaning blade. That is, the cured region was formed only on one surface, the vertical surface (second surface) of the elastic member.

The treatment condition E was the same as the treatment condition D except that the heat treatment temperature in the electric furnace was changed to 40° C.

In the treatment condition F, 100 parts of an acrylic group-containing polydimethylsiloxane (UV3505, commercially available from BYK Japan) as a silicon-containing UV-curable material and 0.5 parts of 2-hydroxy-2-methyl-1-phenyl-propan-1-one (Darocur 1173, commercially available from Ciba Specialty Chemicals) as a photoinitiator were added and mixed to prepare a curable composition. Using the obtained curable composition, in the same manner as in the treatment condition A, the curable composition was applied on each surface of the elastic member. Next, the precursor was swollen in the electric furnace under conditions of 40° C. for 1 hour. Then, the curable composition on the surface of the elastic member was wiped off using a sponge soaked in methyl ethyl ketone as a solvent. Then, the temperature was returned to room temperature, and ultraviolet light was emitted using an ultraviolet emission device (UVC-2534/1MNLC3, commercially available from Ushio Inc.) at an intensity of 140 W/cm² for 5 minutes to obtain a cleaning blade.

In the treatment condition G, a mixture in which 100 parts of a hydroxy group-containing alkyl acrylate (701A, 2-hydroxy-3-methacrylpropyl acrylate, commercially available from Shin-Nakamura Chemical Co., Ltd.) and 2 parts of phenyl(1-hydroxycyclohexyl)ketone (Irgacure 184, commercially available from BASF Japan Ltd.) as a polymerization initiator were diluted with 100 parts of cyclohexanone was used as a curable composition. Using the obtained curable composition, in the same manner as in the treatment condition A, the curable composition was applied on each surface of the elastic member. Next, the precursor was expanded in the electric furnace under conditions of 25° C. for 300 seconds. Then, the curable composition on the surface of the elastic member was wiped off using a sponge soaked in methyl ethyl ketone as a solvent. Then, the temperature was returned to room temperature, and ultraviolet light was emitted using an ultraviolet emission device (UB031-2A/BM, commercially available from Eye Graphics Co., Ltd.) at a distance of 300 mm with a cumulative light amount (ultraviolet light) of 100 J/m².

According to the present disclosure, it is possible to obtain a cleaning blade that minimizes momentary slip-through of a toner remaining on a cleaning target member caused by a change in the contact orientation of the cleaning blade against the cleaning target member when an electrophotographic image forming operation starts or when an electrophotographic image forming operation stops, and contributes to stable formation of high-quality electrophotographic images. In addition, according to another aspect of the present disclosure, it is possible to obtain a process cartridge and an electrophotographic image forming apparatus that contribute to formation of high-quality electrophotographic images.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic cleaning blade comprising an elastic member and a support member that supports the elastic member, wherein
the elastic member has, at a free end portion of the elastic member, a first surface and a second surface that constitutes an edge together with the first surface,
in a cross section perpendicular to a longitudinal direction of the elastic member, and on a straight line that bisects an angle of the edge, when dynamic hardness is measured at measurement positions at 10 μm intervals from the edge,
coefficient of variation of a maximum value DHmax among dynamic hardnesses at the measurement positions in the longitudinal direction of the elastic member is not more than 0.20,
the elastic member has a region where the dynamic hardness decreases from the edge toward the inside of the elastic member, and
in the region where the dynamic hardness decreases, coefficient of variation of a distance L in the longitudinal direction of the elastic member between the edge and a measurement position positioned on an inside of the elastic member when an amount, by which the dynamic hardness decreases at two adjacent measurement positions, becomes not more than 0.04 for the first time is not more than 0.28.

2. The electrophotographic cleaning blade according to claim 1, wherein the elastic member comprises a polyurethane elastomer having a hard segment and a soft segment on a further inside of the elastic member, from the edge on the straight line, than the distance L, and the spin-spin relaxation time (T2_{L}) of the soft segment obtained by pulse NMR measurement of the polyurethane elastomer at a temperature of 50° C. is 250 to 320 μs.

3. The electrophotographic cleaning blade according to claim 1, wherein, the elastic member comprises a polyurethane elastomer having a hard segment and a soft segment on a further inside of the elastic member, from the edge on the straight line, than the distance L, and in FT-IR measurement of the polyurethane elastomer using diamond as an ATR crystals, a value of a ratio of a peak intensity at 1,415 cm⁻¹ to a peak intensity at 1,538 cm⁻¹ is 0.50 to 0.65.

4. The electrophotographic cleaning blade according to claim 1, wherein the elastic member comprises a polyurethane elastomer having a hard segment and a soft segment on a further inside of the elastic member, from the edge on the straight line, than the distance L, and
when an amount of all ions detected, which is obtained when the polyurethane elastomer is heated to 1,000° C. at a ramp rate of 10° C./s using a direct sample introduction type mass spectrometer that heats and vaporizes a sample in an ionization chamber and ionizes sample molecules, is M1, and
when integrated intensity of peaks in an extracted ion thermogram derived from polymeric MDI and corresponding to an m/z value range of 380.5 to 381.5 is M2,
M2/M1 is less than 0.0010.

5. The electrophotographic cleaning blade according to claim 1, wherein the elastic member is obtained by impregnating at least a part of at least one surface, selected from the group consisting of a surface corresponding to the first surface and a surface corresponding to the second surface of the elastic member in a precursor of the elastic member, with a curable composition and curing the curable composition.

6. A process cartridge comprising an electrophotographic cleaning blade, wherein
the electrophotographic cleaning blade comprising an elastic member and a support member that supports the elastic member, wherein
the elastic member has, at a free end portion of the elastic member, a first surface and a second surface that constitutes an edge together with the first surface,
in a cross section perpendicular to a longitudinal direction of the elastic member, and on a straight line that bisects an angle of the edge, when dynamic hardness is measured at measurement positions at 10 μm intervals from the edge,
coefficient of variation of a maximum value DHmax among dynamic hardnesses at the measurement positions in the longitudinal direction of the elastic member is not more than 0.20,
the elastic member has a region where the dynamic hardness decreases from the edge toward the inside of the elastic member, and
in the region where the dynamic hardness decreases, coefficient of variation of a distance L in the longitudinal direction of the elastic member between the edge and a measurement position positioned on an inside of the elastic member when an amount, by which the dynamic hardness decreases at two adjacent measurement positions, becomes not more than 0.04 for the first time is not more than 0.28.

7. An electrophotographic image forming apparatus comprising an electrophotographic cleaning blade, wherein
the electrophotographic cleaning blade comprising an elastic member and a support member that supports the elastic member, wherein
the elastic member has, at a free end portion of the elastic member, a first surface and a second surface that constitutes an edge together with the first surface,
in a cross section perpendicular to a longitudinal direction of the elastic member, and on a straight line that bisects an angle of the edge, when dynamic hardness is measured at measurement positions at 10 μm intervals from the edge,
coefficient of variation of a maximum value DHmax among dynamic hardnesses at the measurement positions in the longitudinal direction of the elastic member is not more than 0.20,
the elastic member has a region where the dynamic hardness decreases from the edge toward the inside of the elastic member, and
in the region where the dynamic hardness decreases, coefficient of variation of a distance L in the longitudinal direction of the elastic member between the edge and a measurement position positioned on an inside of the elastic member when an amount, by which the dynamic hardness decreases at two adjacent measurement positions, becomes not more than 0.04 for the first time is not more than 0.28.
